(19) United States
(12) Patent Application Publication
(10) Pub. No.: US 2010/0244351 A1
(43) Pub. Date: Sep. 30, 2010

(54) APPARATUS, SYSTEM, AND METHOD FOR TUNING A SKI

(76) Inventor: Peter Totman, Ogden, UT (US)

Correspondence Address: Kunzler Needham Massey & Thorpe, 8 EAST BROADWAY, SUITE 600, SALT LAKE CITY, UT, 84111, US

(21) Appl. No.: 12/749,256

(22) Filed: Mar. 29, 2010

Related U.S. Application Data
(60) Provisional application No. 61/164,321, filed on Mar. 27, 2009.

(51) Int. Cl. A63C 11/04; B25H 1/00; B25H 1/10

(52) U.S. Cl. 269/296; 269/303; 269/329

(57) ABSTRACT

An apparatus, system, and method are disclosed for retaining a ski in a position to maintain the ski. The apparatus includes a first support positioned between the front portion of the ski and a support structure to support a front portion of the ski. A second support is positioned between the rear portion of the ski and the support structure to support a rear portion of the ski. A binder engagement including a rigid engagement element engages only one of a binder toe piece and a binder heal piece of a binder. A coupling member couples the binder engagement to the support structure and prevents movement of the ski relative to the support structure in a forward and rearward direction. The supports and the binder engagement apply forces in an opposite direction to secure the ski to the apparatus.

### CROSS-REFERENCES TO RELATED APPLICATIONS

This application claims priority to U.S. Provisional Patent Application No. 61/164,321 entitled “Apparatus and System for Tuning a Ski” and filed on Mar. 27, 2009 for Peter Totman, which is incorporated herein by reference.

### FIELD OF THE INVENTION

This invention relates to an apparatus and method for tuning a ski and more particularly relates to an apparatus and method for retaining a ski in a position to maintain the ski.

### BACKGROUND

Skiers have known for a long time that skis perform better if the sliding surface is smooth and the edges of skis with edges are sharp. Rocks and other debris encountered on the ski slope or ski course can damage the bottom and edges of skis and reduce their performance. The bottoms of skis can also deteriorate with time. Wax is applied to the bottoms of skis to preserve them and make them faster. Ski racers spend a great deal of time making sure the bottoms of the skis provide the greatest performance for the race conditions.

All the work to the bottom of the ski ultimately requires that loads are applied to the ski, which would mean that a non-supported ski would move. The damage to the bottoms of skis is filled, and the residual filler material is scraped off. The edges of downhill skis are filed on both the bottom and on the sides. After the wax is applied all but a very thin layer is scraped off. After the wax is scraped the surface is brushed. While the wax and filler applications do not require that the ski is secured in place, the skis must be locked in place to prevent motion during the scraping, filing and brushing operations.

### SUMMARY

From the foregoing discussion, it should be apparent that a need exists for an apparatus, system, and method that retains a ski in a position to service the base surface and edges of the ski. Beneficially, such an apparatus, system, and method would provide a safe, simplistic design adaptable to a variety of boot sizes.

The present invention has been developed in response to the present state of the art, and in particular, in response to the problems and needs in the art that have not yet been fully solved by currently available ski tuning devices. Accordingly, the present invention has been developed to provide an apparatus, system, and method for retaining a ski in a position to tune a base surface or edge of a ski that overcome many or all of the shortcomings in the art.

The apparatus to retain a ski in a position to maintain the ski is provided with a first support, a second support, a binder engagement, and a coupling member. The first support supports a front portion of a ski having a tunable base surface opposite a deck surface. The first support is positioned between the front portion of the ski and a support structure. The second support is positioned between the rear portion of the ski and the support structure.

The binder engagement is coupleable to the support structure and positioned between the first and second supports. The binder engagement includes a rigid engagement element that engages a binder coupled to the deck surface of a center portion of the ski. The binder includes at least one of a binder toe piece and a binder heal piece with the binder engagement is engageable with only one of the binder toe piece and the binder heal piece.

The coupling member couples the binder engagement to the support structure and prevents movement of the ski relative to the support structure in a forward and rearward direction.

When the binder engagement engages the binder, the binder engagement applies a restricting force to the center portion of the ski. The restricting force limits the distance between the center portion of the ski and the support structure. The first support and the second support apply an opposing force to the front portion and the rear portion of the ski respectively. The opposing forces are applied in a direction substantially opposite the restricting force to retain the ski.

The first and second supports, in one embodiment, include a slip resistant material that prevents movement of the front and rear portions of the ski in a plane parallel with the ski.

The coupling member, in certain embodiments, also applies a support force in a same direction as the opposing forces applied by the first and second supports such that the center portion of the ski is supported when pressure is applied to the center portion of the ski.

In certain embodiments at least one of the first support, the second support, and the coupling member comprises at least one adjusting member. The at least one adjusting member adjusting a distance between the support structure and at least one of the front portion of the ski, the center portion of the ski, and the rear portion of the ski. Adjustment of the at least one adjusting member adjusts a pressure between at least one of the front portion of the ski and the first support and the rear portion of the ski and the second support.

In one embodiment, the coupling member includes the at least one adjusting member. Adjusting the at least one adjusting member decreases a distance between the center portion of the ski and the support structure to increase the pressure between the front portion of the ski and the first support member and increase the pressure between the rear portion of the ski and the second support. The increased pressure increases a frictional resistance between the front portion of the ski and the first support and the rear portion of the ski and the second support. The increased frictional resistance decreases lateral movement of the ski with respect to the first support and the second support.

In another embodiment at least one of the first support and the second support includes at least one adjusting member. Adjusting the at least one adjusting member on the first support and/or the second support increases a distance between the support structure and the front portion and/or the rear portion of the ski to increase the pressure between the front portion and/or the rear portion of the ski and the first support and/or the second support. The increased pressure increases a frictional resistance between the front portion of the ski and the first support and/or the rear portion of the ski and the second support. The increased frictional resistance decreases lateral movement of the ski with respect to the first support and the second support.

The apparatus, in a further embodiment, includes a binder retainer. The binder toe piece includes a recess positioned on one side of the binder toe piece. The binder engagement is receivable within the recess of the binder toe piece. The binder retainer encircles the binder toe piece and adjustably couples to the binder engagement to retain the binder engagement within the recess on the binder toe piece.

In another embodiment, the binder heal piece includes a recess positioned on one side of the binder heal piece and the binder engagement is received within the recess of the binder heal piece. The binder retainer encircles the binder heal piece and adjustably couples to the binder engagement to retain the binder engagement within the recess on the binder heal piece.

The apparatus, in another embodiment, includes a binder engagement member coupled to the binder engagement. The binder engagement member extends through an opening in the binder to couple the binder to the binder engagement.

In certain embodiments the first support and the second support each include a ski receiving surface. The ski receiving surface maintains contact with substantially a same surface area of the deck surface of the ski as an angle of the ski changes in response to a pressure applied along the base surface of the ski.

In a further embodiment, the ski receiving surfaces of the first support and the second support are positioned opposite a semicircular rolling surface of the first support and the second support. The semicircular rolling surface adjusts an angle of the ski receiving surface as the semicircular rolling surface is rolled in a direction of a pressure applied to base surface of the ski. In this manner the ski receiving surface maintains contact with substantially the same surface area of the deck surface of the ski as pressure is applied along the base surface of the ski.

In one embodiment the ski receiving surfaces of the first support and the second support are each pivotably coupled to a base by a pivot attachment. The pivot attachment operates to adjust an angle of the ski receiving surface as pressure is applied along the base surface of the ski.

The apparatus, in certain embodiments, also includes a binder engagement hinging member coupled to the binder engagement. The binder engagement hinging member adjusting a position of the binder engagement between a base servicing position and an edge servicing position. In the base servicing position the binder engagement is substantially parallel to the support structure. In the edge servicing position the binder engagement is substantially perpendicular to the support structure.

In one embodiment the first support and the second support each include a ski profile receiving slot that receives a profile of the ski with the binder engagement engaging the binder in the edge servicing position. In this manner the ski is positioned and maintained in the edge servicing position.

A method of the present invention is also presented for retaining a ski in a position to maintain the ski. The method in the disclosed embodiments substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a ski tuning apparatus having two skis attached;

FIG. 2 is a perspective view illustrating one embodiment of the bottom of a ski tuning apparatus having two skis attached;

FIG. 3 is blown up partial view of the binder attachment area of FIG. 2 showing one embodiment of an interaction of a coupling member with a binder engagement;

FIG. 4 is a perspective view illustrating one embodiment of a ski tuning apparatus having a telemark ski attached to one side of the ski tuning apparatus;

FIG. 5 is a perspective view illustrating one embodiment of the bottom of a ski tuning apparatus having a telemark ski attached to one side of the ski tuning apparatus;

FIG. 6 is a blown up partial view of the telemark binder attachment area of FIG. 5 showing one embodiment of an interaction of an engagement and retainer with the toe piece of a telemark binder;

FIG. 7 is a perspective view illustrating one embodiment of a ski tuning apparatus having a cross-country or skate ski attached to one side of the ski tuning apparatus;

FIG. 8 is a blown up partial view of the cross-country or skate binder attachment area of FIG. 7 showing one embodiment of an interaction of binder rod with a receiving slot of a cross-country or skate ski binder;

FIG. 9 is a perspective view illustrating one embodiment of the bottom of a ski tuning apparatus having a cross-country or skate ski attached to one side of the ski tuning apparatus;

FIGS. 10 and 11 are perspective view illustrating rocking support carriages;

FIG. 12 is a perspective view illustrating one embodiment of a ski tuning apparatus for tuning a single cross-country or skate ski at a time;

FIG. 13 is a side view illustrating one embodiment of a ski tuning apparatus for tuning a single alpine or all terrain ski at a time;

FIG. 14 is a perspective view illustrating one embodiment of a ski tuning apparatus having hinged engagements for tuning a base and edges of a ski;

FIG. 15 is a perspective view illustrating one embodiment of a support having a ski profile receiving slot;

FIG. 16 is a perspective view illustrating one embodiment of a ski tuning apparatus having rocking supports;

FIG. 17 is an exploded perspective view illustrating one embodiment of the coupling member, binder retainer, and binder engagement of FIG. 16;

FIG. 18 is a perspective view illustrating one embodiment of a binder retainer;

FIG. 19 is a side view illustrating one embodiment of a ski tuning apparatus having adjustable supports;

FIG. 20 is a cutaway perspective view illustrating one embodiment of an adjustable support for use with a ski tuning apparatus; and

FIG. 21 is a schematic block diagram illustrating one embodiment of a method for retaining a ski in a position to maintain the ski.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Furthermore, the features, structures, or characteristics described may be combined in any suitable manner in one or more embodiments. In the following description, numerous specific details are provided for a thorough understanding of embodiments of the subject matter. One skilled in the relevant art will recognize, however, that the technology may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

This current specification describes several embodiments of a ski tuning apparatus that engages a “ski binder.” One of skill in the art will recognize that the term “ski binder” can be used interchangeably with the term “ski binding.” Accordingly, the scope of the present invention should not limited by interchangeable terminology. In certain embodiments, the ski binder may be a cross-country ski binder, a skate ski binder, an alpine ski binder, an all-terrain ski binder (AT binder), a telemark ski binder, or any other ski binder known in the art. Thus, a “binder” includes any system by which a user's foot may be attached to a ski.

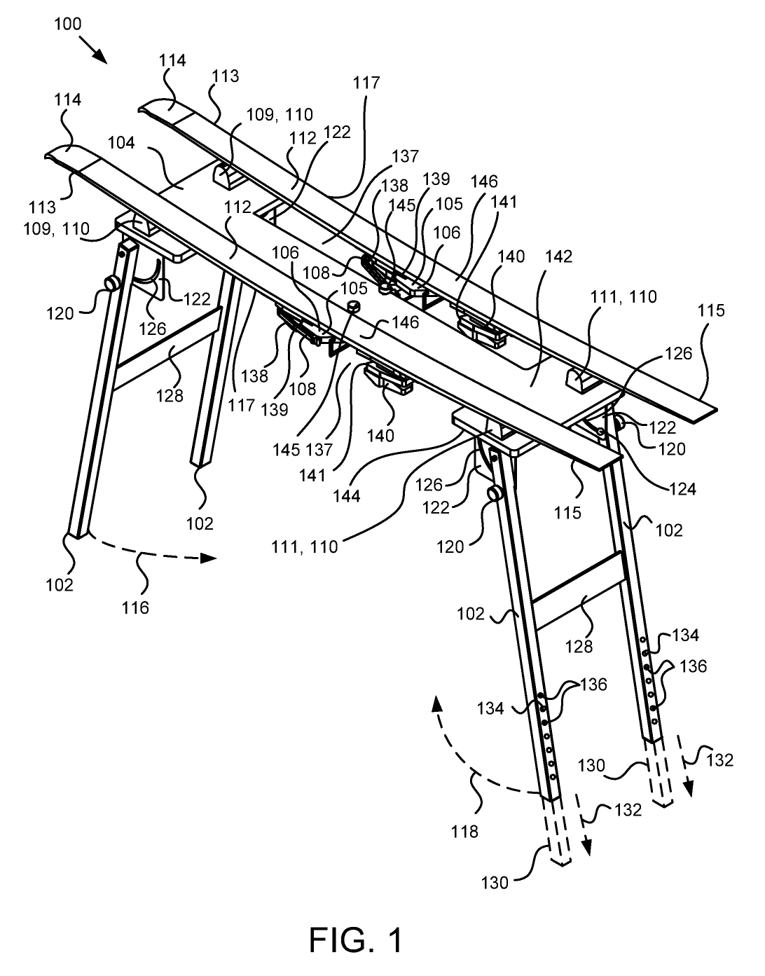

FIG. 1 a ski tuning apparatus 100 according to one embodiment. In certain embodiments the ski tuning apparatus 100 includes a support structure 104 having legs 102. The ski tuning apparatus 100 also includes binder engagements 106, binder retainers 108, first supports 109, and second supports 111 (the first supports 109 and the second supports 111 collectively referred to herein as supports 110). The embodiment illustrated in FIG. 1 depicts a ski tuning apparatus 100 that accepts two skis 114, accordingly, the ski tuning apparatus 100 is described herein with reference to a ski tuning apparatus 100 that accepts two skis 114. However, one of skill in the art will recognize that in certain embodiments the ski tuning apparatus 100 may be configured to accept one ski 114 at a time. In such an embodiment the ski tuning apparatus may be substantially similar to the ski tuning apparatus 100 and may include a single binder engagement 106, a single binder retainer 108, a single first support 109, and a single second support 111.

The supports 110 support the tips and tails of the skis 114 above the support structure 104. The first supports 109 support a front portion 113 of the skis 114 and the second supports 111 support a rear portion 115 of the skis 114. Each ski 114 includes a tunable base surface 112 opposite a deck surface 117. In the embodiment illustrated in FIG. 1, the skis 114 are positioned with the base surfaces 112 facing up and the deck surfaces 117 facing the support structure 104. In such a position a user has easy access to the base surfaces 112 to tune the base surfaces 112.

The first supports 109 are positioned between the front portion 113 of the skis 114 and a support structure 104. The second supports 111 are positioned between rear portions 115 of the skis 114 and the support structure 104. In one embodiment the front portions 113 of the skis 114 includes the area of the skis 114 near the tips of the ski 114 and the rear portions 115 of the skis 114 includes of the area near the tails of the skis 114. In certain embodiments the front portions 113 of the skis 114 includes the area from the toe pieces 138 of the binders to the tips of the skis 114. In another embodiment the rear portions 115 of the skis 114 includes the area from the heal pieces 140 of the binders to the tails of the skis 114. In one embodiment the center portions 146 of the skis 114 includes the area between the front portions 113 of the skis 114 and the rear portions 115 of the skis 114. In another embodiment the center portions 146 of the skis 146 includes the areas adjacent to the binders.

In certain embodiments the first supports 109 and the second supports 111 may be adjustable such that the first supports 109 may be adjustably positioned anywhere along the areas defining the front portions 113 of the skis 114 and the second supports 111 may be positioned anywhere along the areas defining the rear portions 115 of the skis 114. In one embodiment the first supports 109 and the second supports 111 may be adjustably coupled to the support structure 104 allowing the first supports 109 and the second supports 111 to be positioned anywhere along the areas defining the front portions 113 of the skis 114 and the rear portions 115 of the skis 114 respectively. In another embodiment, the first supports 109 may be permanently affixed to the support structure 104 at positions near the front portions 113 of the skis 114 and the second supports 111 may be permanently affixed to the support structure 104 at positions near the rear portions 115 of the skis 114. In yet another embodiment, the first supports 109 and the second supports 111 may be loosely placed on the support structure 104 anywhere along the areas defining the front portions 113 of the skis 114 and the rear portions 115 of the skis 114 respectively without any coupling to the support structure 104.

The first supports 109 may be made of a slip resistant material that prevents movement of the front portions 113 of the skis 114 in a plane parallel with the skis 114. The second support 111 may also be made of a slip resistant material that prevents movement of the rear portions 115 of the skis 114 in a plane parallel with the skis 114. In certain embodiments the first supports 109 and the second supports 111 may be made of a rubberized material that increases a frictional resistance between the deck surfaces 117 of the skis 114 and the supports 110 as pressure is increased between the deck surfaces 117 of the skis 114 and the supports 110. In one embodiment only the surfaces of the supports 110 that come in contact with the deck surfaces 117 of the skis 114 are made of a slip resistant material. In other embodiments the entire supports 110 are made of a slip resistant material. In one embodiment the support structure 104 includes slip resistant material in the areas under the supports 110 to help keep the supports 110 in place during operation.

In one embodiment an increased pressure between the first supports 109 and the deck surfaces 117 of the skis 114 and an increased pressure between the second supports 111 and the deck surfaces 117 of the skis 114 may result from pressure applied to the base surfaces 112 of the skis 114 when the base surfaces 112 are maintained by a user. In another embodiment, further discussed below, an increased pressure between the first supports 109 and the deck surfaces 117 of the skis 114 and the increased pressure between the second supports 111 and the deck surfaces 117 of the skis 114 results from a restricting force applied to the center portions 146 of the skis 114 when the binder engagements 106 are engaged with the binders. The restricting force may limit the distance between the center portions of the skis 114 and the support structure 104.

The first supports 109 and the second supports 111 support the front portions 113 of the skis 114 and the rear portions 115 of the skis 114 respectively to apply an opposing force to the front portions 113 of the skis 114 and the rear portions 115 of the skis 114. The opposing force is applied in a direction opposite the restricting force to secure the skis 114 to the ski tuning apparatus 100.

In certain embodiments the restricting force may be applied or increased on the center portions 146 of the skis 114 by engaging the binder engagements 106 with the binders which are coupled to the center portions 146 of the skis. The heights of the binder engagements 106 with respect to the support structure 104 may then be adjusted to apply or increase the restricting force applied to the center portions 146 of the skis 114. For example, the binders may include a binder toe piece 138, a binder heal piece 140, or both coupled to the center portions 146 of the skis 114. By engaging the binders with the binder engagements 106 and adjusting the height of the binder engagements 106 relative to the support structure 104, the restricting force is transferred from the binder engagements 106 to the center portions 146 of the skis 114.

Coupling members (not shown in FIG. 1) couple the binder engagements 106 to the support structure 104 to prevent the binder engagements 106 from moving in a forward or rearward direction. The coupling members (not shown in FIG. 1) may include a substantially rigid structure that rigidly couples the binder engagements 106 to the support structure 104 preventing movement of the binder engagements in a forward or rearward direction with respect to the support structure 104. By preventing movement of the binder engagements 106 in a forward or rearward direction, the skis 114 are prevented from moving in a forward or rearward direction when pressure is applied to the skis 114 during a ski tuning process. In one embodiment, the coupling members (not shown in FIG. 1) may also support the binder engagements 106 such that a support force is applied to the center portions 146 of the skis 114. The support force may be applied in substantially the same direction as the opposing force applied by the first supports 109 and the second supports 111.

The binder engagements 106 include a rigid engagement element 105 that engages the binder toe piece 138 or the binder heal piece 140 to couple the center portions 146 of the skis 114 to the apparatus 100. By using a rigid engagement element 105 to couple to the binder toe piece 138 or the binder heal piece 140, movement of the skis 114 in the forward or rearward direction is prevented. The rigid engagement elements 105 are positioned within a recess on the binder toe pieces 138 or the binder heal pieces 140 such that movement the center portions 146 of the skis 114 away from the binder engagements 106 is limited. The use of a rigid engagement element 105 to engage the binder toe pieces 138 or the binder heal pieces 140 operates to transfer the restricting force to the center portions 146 of the skis 114 and limits the possibility of play or movement between the binder engagements 106 and the binder toe pieces 138 or the binder heal pieces 140. The rigid engagement element 105 also operates to engage the binder toe pieces 138 or the binder heal pieces 140 in a fashion substantially similar to the way a toe or heal of a boot engages the binder toe pieces 138 or the binder heal pieces 140. Thus, the use of a rigid binder engagement element 105 limits the possibility of apply the restricting force to the binder toe pieces 138 or the binder heal pieces 140 in a manner for which the binder toe pieces 138 or the binder heal pieces 140 were not designed.

The binder engagements 106 engage only one of the binder toe piece 138 or the binder heal piece 140. By engaging only one of the binder toe piece 138 or the binder toe piece 140, the binder engagements 106 need not include a size adjustment to adjust the size of the binder engagements 106 to fit binders which are sized to fit different sized boots. For example, a binder toe piece 138 and a binder heal piece 140 spaced to fit a size 10 boot will typically be spaced further apart than a binder toe piece 138 and a binder heal piece 140 spaced to fit a size 9 boot. Accordingly, in order for a binder engagement 106 to fit different sized boots, a binder engagement 106 that engages both the binder toe piece 138 and the binder heal piece 140 would need to include a size adjustment. By only engaging one of the binder toe piece 138 or the binder heal piece 140 with binder engagements 106 that do not span the distance between the binder toe piece 138 and the binder heal piece 140, the binder engagements 106 can accommodate binders spaced to fit a variety of sizes of boots.

In one embodiment the restricting force is applied or increased by adjusting a height of the binder engagements 106 with respect to the support structure 104. For example, in certain embodiments the binder engagements 106 are coupled to the support structure 104. The binder engagements 106 engage the binders to couple the binders to the binder engagement 106. Because the binders are coupled to the center portions 146 of the deck surfaces 117 of the skis 114, the binder engagements 106 are effectively coupled to the center portions 146 of the skis 114. Adjustment of a height of the binder engagements 106 with respect to the support structure 104 operates to adjust a height of the center portions 146 of the skis 114. In this manner the restricting force applied to the center portions 146 of the skis 114 limits the distance between the center portions 146 of the skis 114 and the support structure 104. The first support 109 and the second support 111 may be of sufficient size to apply the opposing force to the front portions 113 and the rear portions 115 of the skis 114 to secure the skis 114 to the ski tuning apparatus 100.

In another embodiment the restricting force may be applied to the center portions 146 of the skis 114 by engaging the binder engagements 106 with the binder toe pieces 138 or the binder heal pieces 140. The binder engagements 106 may be positioned in a fixed plane parallel to a top surface 142 of the support structure 104 by the coupling member (not shown in FIG. 1). Thus, in one embodiment the binder engagements 106 are positioned in a fixed position at a predefined distance from the top surface 142 of the support structure 104. The opposing force may be adjusted or increased by adjusting the height of the supports 110 with respect to the support structure 104. Taller supports 110 may be used to increase the height or distance between the top surface 142 of the support structure 104 and the front portions 113 and rear portions 115 of the ski 114 while the center portions 146 remains fixed in a fixed plane relative to the top surface 142 of the support structure 104 by operation of engagement of the binder engagements 106 with the binder toe pieces 138 or the binder heal pieces 140. In certain embodiments the height of the supports 110 may be adjustable to increase or decrease the distance between the support structure 104 and the front portions 113 and the rear portions 115 of the skis 114. Thus, in certain embodiments the supports 110 may each include an adjusting member (not shown) that adjusts the height of the supports 110. Increasing the distance between the support structure 104 and the front portions 113 or the rear portions 115 of the skis 114 while keeping the center portion 146 of the skis 114 fixed acts as a lever to secure the skis 114 to the ski tuning apparatus 100. One of skill in the art will recognize that each support 110 may include an adjusting member (not show) or a single adjusting member may adjust the height of all of the supports 110 simultaneously.

In certain embodiments the first supports 109 and the second supports 111 are identical supports and are thus interchangeable. In another embodiment the first supports 109 may be specifically shaped to support the front portions 113 of the skis 114 and the second supports 111 may be specifically shaped to support the rear portions 115 of the skis 114.

In certain embodiments at least one of the first supports 109, second supports 111, and the coupling members (not shown in FIG. 1) include at least one adjusting member 146. The adjusting member 146 adjusts a distance between the support structure 104 and at least one of the front portions 113, the center portions 146, and the rear portions 115 of the skis 114 to increase or decrease the pressure between at least one of the front portions 113 of the skis 114 and the first supports 109 and the rear portions 115 of the skis 114 and the second supports 111.

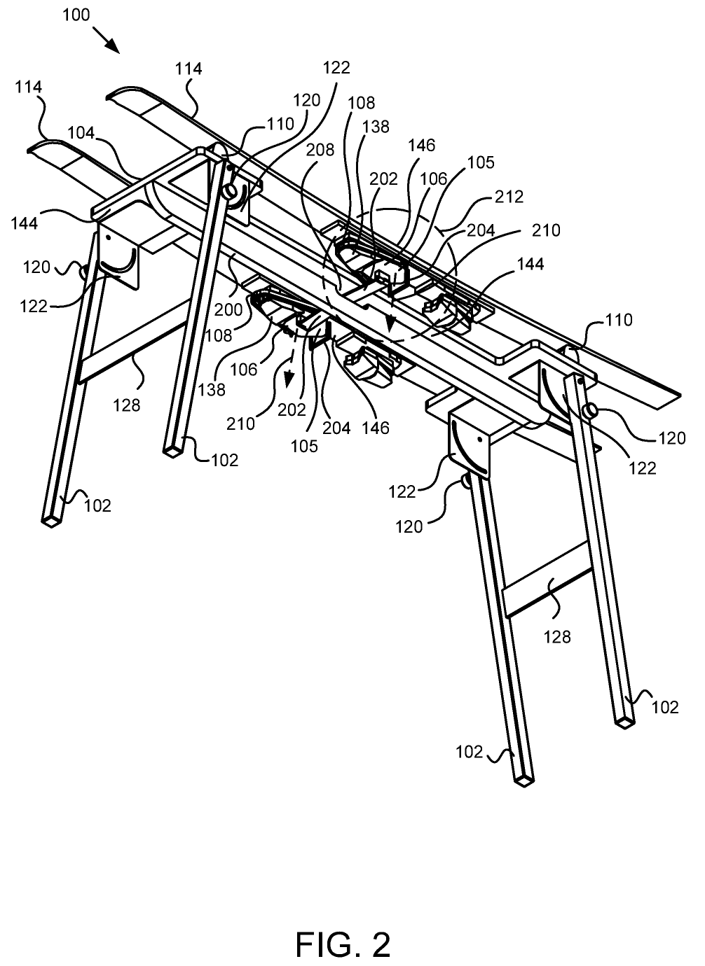

As further discussed below with reference to FIG. 2, the coupling member 202 is a hinged support bracket coupled to the bottom surface 144 of the support structure 104. The coupling member 202 may include adjusting members 145 (illustrated in FIG. 1) that operate to increase or decrease the distance between the binder engagements 106 and the support structure 104. The hinged support bracket of the coupling member 202 allows the distance between the binder engagements 106 and the support structure to be adjusted. The hinged support bracket of the coupling member 202 allows the binder engagements 106 to travel in the direction indicated by arrows 210 while keeping the binder engagements 106 in the same forward and rearward position. Thus, even when pressure is applied to the base surfaces 112 of the skis 114, causing the center portions 146 of the skis 114 to flex, the binder engagements 106, and thus the skis 114, are maintained in the same forward and rearward position relative to the support structure 104.

Decreasing the distance between the center portions 146 of the skis 114 and the support structure 104 while supporting the front portions 113 and the rear portions 115 of the skis 114 with the front support 108 and the rear support 111 increases the pressure between the front portion 113 of the ski 114 and the first support 109 and increase the pressure between the rear portion 115 of the ski 114 and the second support 111. The increased pressure between the front portion 113 of the ski 114 and the first support 109 and the increase the pressure between the rear portion 115 of the ski 114 and the second support 111 increases a frictional resistance between the front portion 113 of the ski 114 and the first support 109 and the rear portion 113 of the ski 114 and the second support 111. The increased frictional resistance decreases lateral movement of the ski 114 with respect to the first support 109 and the second support 111.

The adjusting members 145 include adjusting screws that adjust the height of the binder engagements 106 to accommodate varying depths of binders and to provide or adjust the restricting force to the center portions 146 of the skis 114. As the adjusting members 145 are rotated, the adjusting screws force the hinged support bracket of the coupling member 202 to a position closer to or beyond the plane of the top surface 142 of the support structure 104. Because the binder engagements 106 are coupled to the hinged support bracket of the coupling member 202 the binder engagements 106 are also forced to a lower position relative to the top surface 142 of the support structure 104. In certain embodiments the height of the binder engagements 106 may be adjusted by the adjusting members 145 to a position below the plane of the top surface 142 of the support structure 104. In other embodiments the distance between the top surface 142 of the support structure 104 and the binder engagements 106 may be decreased without the binder engagements 106 breaking the plane of the top surface 142 of the support structure 104.

In certain embodiments the adjusting members 145 may engage the hinged support bracket of the coupling member 202 to restrict further upward or downward movement of the binder engagements 106 with respect to the support structure 104. Thus, once the binder engagements 106 are positioned at a desired height relative to the support structure 104 by the adjusting members 145, further movement of the binder engagements 106 in an upward or downward direction may be prevented by the adjusting members 145. In such an embodiment the coupling member 202 may operate to provide both a supporting force and a restricting force to the center portions 146 of the skis 114. As discussed above, because the coupling member 202 is rigid, movement of the binder engagements 106, and thus the skis 114, in the forward or rearward direction is also limited by the operation of the coupling member 202. In other embodiments the adjusting members 145 are not configured to engage the coupling member 202 but simply press on the coupling member 202 to lower the coupling member 202. In such an embodiment the adjusting members 145 may only operate to lower the coupling member 202 with respect to the support structure 104 but may not provide a support force to the binder engagements 106.

When the binder engagements 106 are engaged in the toe pieces 138 of the binders and the adjusting members 145 are rotated in a tightening direction, the binder engagements 106 are forced to a lower position relative to the top surface 142 of the support structure 104. By lowering the height of the binder engagements 106 with the binder engagements 106 engaging the binder, the center portion 146 of the skis 114 are forced to a lower position relative to the support structure 104. The front portions 113 and the rear portions 115 of the skis 114 are supported by the supports 110 which apply the opposing force to the front portions 113 and the rear portions 115 of the skis 114. Decreasing the distance between the center portions 146 of the skis 114 and the support structure 104 increases the pressure between the front portions 113 and the rear portions 115 of the skis 114. Friction between the supports 110 and the front portions 113 and the rear portions 115 of the skis 114 limits lateral movement of the ends of the skis 114 and secures the skis 114 to the ski tuning apparatus 100.

The amount of friction between the skis 114 and the supports 110 can be adjusted by rotating the adjusting members 145 in a tightening direction or a loosening direction, adjusting the height of the binder engagements 106 with respect to the top surface 142 of the support structure 104. The restricting force is applied to the center portions 146 of the skis 114 is applied perpendicular to the skis 114 in the direction of the support structure 104. The opposing forces are also applied perpendicular to the skis 114 but in a direction opposite the restricting force. The opposing forces act to increase a pressure between the skis 114 and the supports 110. This increased pressure between the skis 114 and the supports 110 limits the movement of the front portions 113 and the rear portions 115 of the skis 114 in a plane parallel with the skis 114. In certain embodiments increased pressure also prevents the skis 114 from other movement such as preventing the skis 114 from rolling off of the supports 110.

In one embodiment the binder engagements 106 may be positioned in a fixed position a predefined distance above the support structure 104 and at least one of the first supports 109 and the second supports 111 may include at least one adjusting member (not shown). The at least one adjusting member (not shown) on at least one of the first support 109 and the second support 111 may adjust a distance between the support structure 104 and at least one of the front portions 113 of the ski 114 and the rear portions 115 of the skis 114. In one embodiment the at least one adjusting member (not shown) on at least one of the first support 109 and the second support 111 increases a distance between the support structure 104 and at least one of the front portions 113 of the ski 114 and the rear portions 115 of the skis 114. For example, in one embodiment the first supports 109 may include adjusting members (not shown) that increase or decrease the distance between the support structure 104 and the front portions 113 of the skis 114. In another embodiment the second supports 111 may include adjusting members (not shown) that increase or decrease the distance between the support structure 104 and the rear portions 115 of the ski 114. In yet another embodiment, both the first supports 109 and the second supports 111 include adjusting members (not shown).

The adjusting members (not shown) on the first supports 109 and/or the second supports 111 operate to increase or decrease the distance between the support structure 104 and front portions 113 and/or the rear portions 115 of the ski 114 while the center portions 146 of the skis 114 remain in a fixed position by operation of the binder engagements 106. Increasing the distance between the support structure 104 and front portions 113 and/or the rear portions 115 of the ski 114 while keeping the center portions 146 of the skis 114 in a fixed position increases pressure between at least one of the front portions 113 of the ski 114 and the first support members 109 and the rear portions 115 of the skis 114 and the second supports 111. The increased pressure increases a frictional resistance between at least one of the front portions 113 of the skis 114 and the first supports 109 and the rear portions 115 of the skis 114 and the second supports 111. The increased frictional resistance decreases lateral movement of the skis 114 with respect to the first supports 109 and the second supports 111.

In certain embodiments the ski tuning apparatus 100 includes binder retainers 108 that adjustably couple the binder engagements 106 to the toe piece 138 or binder heal piece 140. In embodiments where the skis 114 include alpine or AT binders the binder retainers 108 may couple the binder engagements 104 to the binder toe piece 138 or the binder heal piece 140. In embodiments where the binder only includes a binder toe piece, such as where the skis 114 include Nordic, cross-country, or skate ski binders, the binder retainers 108 may couple the binder engagements 106 to the binder toe piece 138.

The embodiment illustrated in FIG. 1 depicts the skis 114 as including binder toe pieces 138 and binder heal pieces 140. The binder toe pieces 138 include a recess 139 for receiving the binder engagement 106. One of skill in the art will recognize that the recesses 139 in the binder toe pieces 138 may be the same recesses that receive the toe flanges of ski boots (not shown) when a user uses the skis 114. The binder engagements 106 are received within the recesses 139 of the binder toe pieces 138. The binder retainers 108 encircle the binder toe pieces 138 and adjustably couple the binder engagements 106 to the toe pieces 138. The binder retainers 108 may be a cam strap, a rope, a belt, a bungee cord or the like. The binder retainers 108 may include cam buckles, over-center fasteners, ratchet fasteners or other fastening devices to aid in retaining the binder engagement 106 in the binder toe piece 138 and to provide a way to increase tension on the binder retainers 108. In one embodiment the binder retainers 108 may include a ratchet strap such as is found on a snowboard binding to provide a mechanical aid to increase tension on the binder retainers 108.

While the embodiment illustrated in FIG. 1 shows the binder engagements 106 engaging the binder toe pieces 138, one of skill in the art will recognize that in certain embodiments the binder engagements 106 may engage the binder heal pieces 140. For example, the binder heal pieces 140 include recesses 141. The binder engagements 106 may be received within the recesses 141 of the binder heal pieces 140. The binder retainers 108 may encircle the binder heal pieces 140 and adjustably couple the binder engagements to the heal pieces 140. Where the binder heal pieces 140 are engaged by the binder engagements 106, care should be taken to ensure the binder heal pieces 140 do not open as a result of stress or force placed on the base surfaces 112 of the skis 114.

While the embodiment illustrate in FIG. 1 depicts a ski tuning apparatus 100 that includes a support structure 104 designed to accommodate the ski tuning apparatus 100, one of skill in the art will recognize that the ski tuning apparatus 100 may be used with an existing support structure (not shown) such as a table or other structure that supports the ski tuning apparatus 100. Indeed, in one embodiment the ski tuning apparatus 100 may be positioned on a floor surface or other surface on the ground. Thus, in certain embodiments the support structure 104 may include a ground surface, a floor surface, a table, or any other supporting surface.

In the embodiment illustrated in FIG. 1, the support structure 104 includes a rigid, planar material having a top surface 142 for supporting the first supports 109 and second supports 111 and a bottom surface 144 for mounting a coupling member (element 202 of FIG. 2) that attaches the binder engagements 106 to the support structure 104. In certain embodiments the coupling member 202 may be mounted on the top surface 142 of the support structure 104.

In certain embodiments the support structure 104 contains binder receiving areas 137 that allow the binders on the skis 114 to extend below the plane of the support structure 104. One of skill in the art will recognize that where the skis 114 are alpine skis, the binders typically include a toe piece 138 and a heal piece 140. Therefore, in certain embodiments the binder receiving areas 137 are big enough to accommodate the toe piece 138 and heal piece 140 of a binder. In other embodiments, such as where a telemark, cross-country, or skate ski is tuned using the ski tuning apparatus 100, the binder receiving areas 137 in the support structure 104 may be sized to accommodate only a toe piece 138. In other embodiments the binder receiving areas 137 may be universal and accommodate alpine skis 114 as well as telemark, cross-country, or skate skis. In yet another embodiment, the skis may be positioned at a sufficient height relative to the support structure 104 to accommodate a height of a binder positioned between the support structure 104 and the deck surface 117 of the skis 114.

In certain embodiments the support structure 104 includes legs 102 that support the support structure 104 at each of the four corners of the support structure 104. While the embodiment illustrated in FIG. 1 shows the support structure 104 having four legs 102, one of skill in the art will recognize that in other embodiments the support structure 104 may have three legs 102 acting as a tripod. In certain embodiments the support structure 104 may rest directly on the ground.

In one embodiment the legs 102 are rigidly mounted to the support structure 104 and are fixed in a standing position to create a stand for working on a ski 114. In embodiments where legs 102 are included, the legs 102 may be foldable to facilitate the transportation of the ski tuning apparatus 100. For example, in the embodiment illustrated in FIG. 1, the legs 102 may be folded inward in the direction indicated by arrows 116 and 118. Once folded inward, the legs 102 may rest against the bottom surface 144 of the support structure 104.

In certain embodiments bolts 124 are positioned through retention fastener slots 126 on hinge plates 122 and through a leg 102 located at each corner of the support structure 104 and coupled to the support structure 104. The bolts 125 are also positioned through each leg 102 and engage leg retention fasteners 120. The leg retention fasteners 120 are threaded onto the bolts 124 and tightened to maintain the desired angle for the legs 102. In certain embodiments the leg retention fasteners 120 may be contoured to increase the comfort for the user when the user tightens the leg retention fasteners 120. To release the legs 102 and fold the ski tuning apparatus 100 for transportation or storage, the leg retention fasteners 120 are released by partially unthreading the leg retention fastener 120 from the bolt 124 allowing the bolts 124 to move freely within the retention fastener slots 126 on the hinge plates 122. Once the legs 102 are positioned adjacent to and parallel with the support structure 104, the leg retention fastener 120 may again be tightened to maintain the legs 102 in a storage or transportation position.

The retention fasteners 120 may be tightened with the bolts 124 located in varying positions within the retention fastener slots 126 to adjust the height or amount support of the support structure 104. For example, where additional support is required, the legs 102 may be fully extended. Where additional height is required, the legs 102 may be positioned such that they are ninety degrees in relation to the support structure 114. In certain embodiments support braces 128 span the distance between two legs 102 to give support to the ski tuning apparatus 100.

In one embodiment, legs 102 may include extensions such as extension 130 that telescopes from the bottom of each leg 102 in the direction indicated by arrow 132. The extensions 130 telescoping from the bottom of each leg 102 may operate independently to adjust the level of the top surface 142 of the support structure 104 on uneven terrain. Once the extension 130 is positioned in a desired position, pins 134 engage holes 136 in the legs 102 to arrest any inward or outward movement of the extensions 130 from within the legs 102. A number of holes 136 may be positioned along the length of each leg 102 to give the user flexibility in adjusting the level of the top surface 142 of the support structure 104. In certain embodiments the ski tuning apparatus 100 is intended for use in a shop or other level area. Therefore in certain embodiments the extensions 130 may be unnecessary and therefore omitted from the ski tuning apparatus 100. While the embodiment illustrated in FIG. 1 only shows two extensions, one of skill in the art will recognize that in certain embodiments each leg 102 may include an extension 130.

FIG. 2 illustrates the bottom surface 144 of a support structure 104 according to one embodiment of the ski tuning apparatus 100. In certain embodiments the ski tuning apparatus 100 includes a support ridge 200, coupling members 202, and binder engagement members 204. Again, the embodiment illustrated in FIG. 2 depicts a ski tuning apparatus 100 that receives two skis 114 and therefore, the ski tuning apparatus 100 will be described with reference to two skis 114. One of skill in the art will recognize that in certain embodiments the ski tuning apparatus 100 may be designed to receive a single ski 114.

In one embodiment the support ridge 200 provides a rigid support beam that runs the length of the support structure 104. The support ridge 200 adds support to the center 206 section of the support structure 104 which allows more force to be applied to the base surfaces 112 of the skis 114. In certain embodiments the support ridge 200 contains a notch 208 that allows the hinged support brackets 202 to move vertically to adjust the tension on the center portions 146 of the skis 114.

As discussed above, the coupling members 202 include a hinged support bracket which is coupled to the binder engagements 106. When the adjusting members 145 are rotated, they force the hinged support bracket of the coupling member 202, and thus the binder engagements 106, downward in the direction indicated by arrows 210. The binder engagements 106, in turn, force the center portions 146 of the skis 114 downward in the direction indicated by arrows 210. Because the front portions 113 and the rear portions 115 of the skis 114 are supported by the supports 110, the center portions 146 of the skis 114 flex. Increasing the force on the center portions 146 of the skis 114 by turning the adjusting members 145 increases the friction between the supports 110 and the front portions 113 and the rear portions 115 of the skis 114. By increasing the friction between the adjustable supports 110 and the front portions 113 and the rear portions 115 of the skis 114, the user can control lateral movement of the front portions 113 and the rear portions 115 of the skis 114.

In one embodiment the coupling members 202 may be a single bracket connected in the center of the support structure 104 by a hinge (not shown). The hinge (not shown) allows the coupling members 202 to operate independently, providing varying degrees of force on each ski 114 depending on the requirements of the various tuning processes. In another embodiment the ski tuning apparatus 100 includes two coupling members 202, with each coupling member 202 operating independently from the other. In yet another embodiment, the coupling members 202 may be a single support that does not include a hinge such that adjustment of the height of the single coupling member 202 operates to adjust the height of both of the binder engagements 106 at the same time.

FIG. 2 illustrates one embodiment of binder engagement members 204 coupled to the binder engagements 106. In certain embodiments the ski tuning apparatus 100 may be used to tune a cross-country or skate ski (not shown). In such an embodiment the binder engagement members 204 extend through an opening in the binders to couple the binders to the binder engagements 106. The binder engagement members 204 may include a rod or bar that couples the binder engagements 106 to a cross-country or skate ski binder, such as a New Nordic Norm (“NNN”) binder, a Back Country (“BC”) binder, a Solomon Nordic System (“SNS”) binder, or other binders that are designed to be attached to a bar or rod on a ski boot. The binder engagement members 204 may be rotatably coupled to the binder engagements 106 such that the binder engagement members 204 may be positioned out of the way when the ski tuning apparatus is used with an alpine or all terrain ski such as ski 114. In one embodiment the binder engagement members 204 may be removable allowing the user to take the binder engagement members 204 off of the binder engagements 106 when the binder engagement members 204 are not in use.

FIG. 2 also illustrates another view of the binder retainers 108 encircling the binder toe pieces 138 to attach the binder engagements 106 to the binder toe pieces 138. Once the binder retainers 108 are fastened around the toe pieces 138, the height of the binder engagements 106 can be adjusted using the adjusting members 145 to increase or decrease the distance between the center portions 146 of the skis 114 and the support structure 104 as discussed above.

Also illustrated in FIG. 2 is one embodiment of the hinge plates 122 that operate to allow the legs 102 to be folded from the storage or transportation position to the standing position. In certain embodiments the hinge plates 122 are L shaped with one leg of the L mounted to the bottom surface 144 of the support structure 104 and the other leg of the L pointing in a ninety degree angle toward the ground. Leg retention fasteners 120 on the hinge plate 122 of each leg 102 operate to fasten the legs 102 in a desired position.

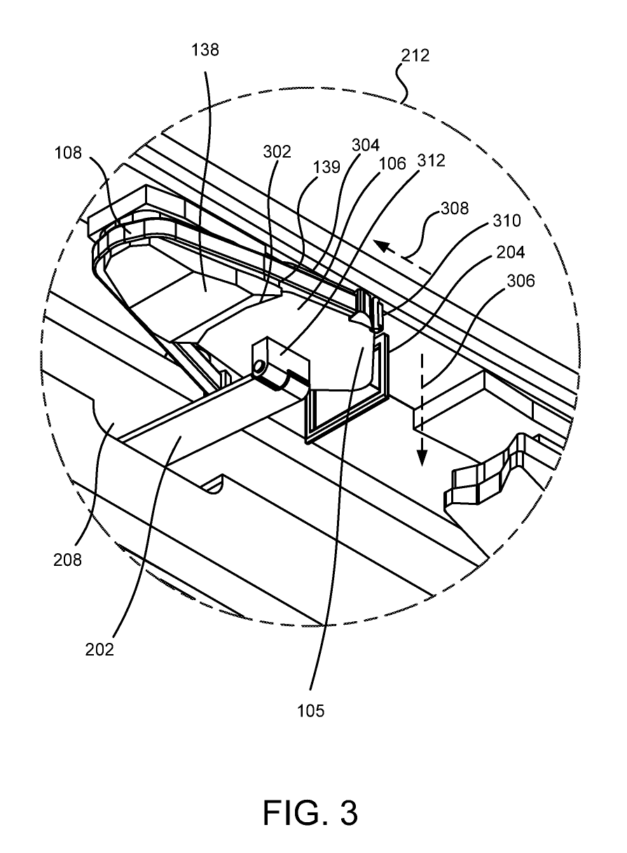

FIG. 3 illustrates a blown up partial view of the binder attachment area 212 of FIG. 2 showing one embodiment of the interaction of the coupling member 202, the binder engagement 106, the binder retainer 108, and the toe piece 138 of the binder of FIGS. 1 and 2.

As discussed above, the binder engagements 106 include a rigid engagement element 105 that engages the toe pieces 138 or heal piece 140 of the binders. The rigid engagement elements 105 of the binder engagements 106 are shaped to be inserted into the recesses 139 of the toe piece 138 of the binder located between the overhangs 302 and the stomp plates 304 of the binder toe pieces 138. The overhangs 302 keeps the binder engagements 106 lodged in the recesses 139 in a fashion similar to the way the overhangs 302 keep toe pieces of a ski boot (not shown) in the recesses 139. In certain embodiments, at least a portion of the rigid engagement element 105 of the binder engagements 106 is shaped substantially similar to the toe piece of a ski boot (not shown) such that the rigid engagement element 139 completely received within the recess 139. Movement of the binder engagement element 105 away from the stomp plates 304 in a direction indicated by arrow 306 is prohibited by the overhangs 302. Lateral movement of the binder engagement element 105 to remove the binder engagement element 106 from within the recess 139 is prohibited by the binder retainer 108 which draw the binder engagement element 106 forward into the recess 139 in the direction indicated by arrow 308. Fasteners 310 attach each end of the binder retainer 108 to connect the binder retainer 108 to the binder engagement element 105. As discussed above, in certain embodiments the binder retainer 108 may be attached to the binder engagement 106 using cam buckles, over-center fasteners, ratchet fasteners or other fastening devices to aid in retaining the binder engagement element 105 in the recess 139 of the binder toe piece 138 and to provide a way to increase tension on the binder retainer 108.

A binder engagement hinging member 312 couples the binder engagement 106 to the coupling member 202. The binder engagement hinging member 312 allows the coupling member 202 to pivot out of plane with the support structure 104 and still maintain a parallel alignment of the binder engagement 106 with the support structure 104. For example, in certain embodiments the coupling member 202 is connected to the support structure 104 at a single point within recess 208. When the adjusting members 145 are rotated to adjust the height of the binder engagements 106 with respect to the support structure 104, the hinged support bracket of the coupling member 202 is angled out of parallel alignment with the support structure 104. The binder engagement hinging member 312 pivots to adjust the plane of the binder engagement element 105 of the binder engagement 106 to align the binder engagement 106 parallel with the support structure 104. Aligning the binder engagement element 105 of the binder engagements 106 parallel to the support structure 104 ensures that the ski 114 will be aligned parallel with the support structure 104.

In certain embodiments, the binder engagement hinging member 312 adjusts a position of the binder engagement between a base servicing position and an edge servicing position. In the base servicing position the binder engagement element 105 of the binder engagements 106 (and thus, the skis 114) is substantially parallel to the support structure 104. In the edge servicing position the binder engagement element 105 of the binder engagements 106 (and thus, the skis 114) is substantially perpendicular to the support structure 104.

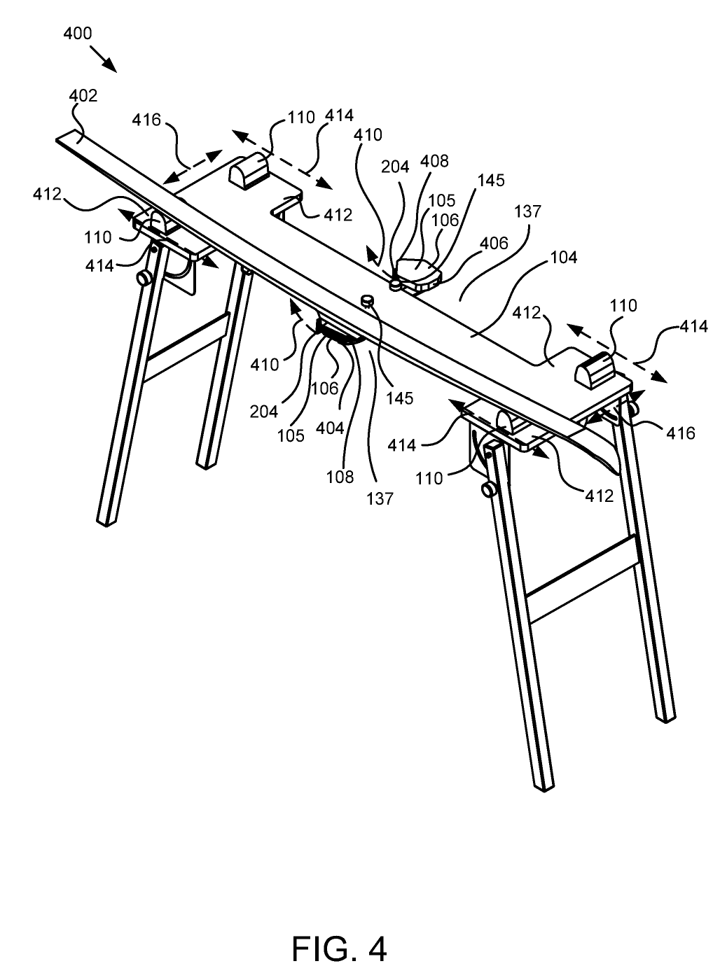

FIG. 4 illustrates another embodiment of a ski tuning apparatus 400 having a telemark ski 402 connected to one of the binder engagements 106. One of skill in the art will recognize that the ski tuning apparatus 400 can be used with a single ski 402, as shown in FIG. 4, as well as with multiple skis 114 as illustrated in FIG. 1.

In certain embodiments the binder engagements 106 are universally shaped to be received in a toe piece 138 of an alpine binder (illustrated in FIGS. 1-3 above), all terrain (“AT”) binder (not shown) or the toe piece 404 of a telemark binder illustrated in FIG. 4.

In certain embodiments each binder engagement 106 has a substantially blunt front end 406 and a relatively tapered rear end 408. The blunt front end 406 is the end received in the toe pieces 138 or heal pieces 140 of the alpine or AT binder or the toe pieces 404 of the telemark binder.

The tapered rear end 408 of the binder engagement 106 provides a relatively narrower area to attach a binder engagement member 204 to the binder engagement 106. The binder engagement member 204 is attached to the binder engagement 106 in a manner that allows the binder engagement member 204 to pivot in the direction indicated by arrows 410 when the ski tuning apparatus 400 is used with a binder that includes an opening for attaching the binder engagement member 204. When a binder does not include an opening for attaching the binder engagement member 204 a user's boot, the binder engagement member 204 can be pivoted to the position illustrated in FIG. 4 to avoid interference of the binder engagement member 204 with a toe piece 404 (or toe piece 138 of an alpine or AT binder).

Supports 110 are movable on support areas 412 of the support structure 104. The supports 110 may be moved in the directions indicated by arrows 414 and 416 to fine tune the adjustment of the supports 110 to support different areas of the skis 402 (or skis 114). In certain embodiments the support areas 412 may be larger than depicted in FIG. 4 to increase the surface area available to move the adjustable supports 110. In one embodiment the support areas 412 on the support structure 104 are covered in a slip resistant material to help maintain the supports 110 in a desired position. One of skill in the art will recognize that in certain embodiments the entire support structure 104 may be covered in the slip resistant material. In another embodiment the support structure 104 may be made of a substantially rigid slip resistant material.

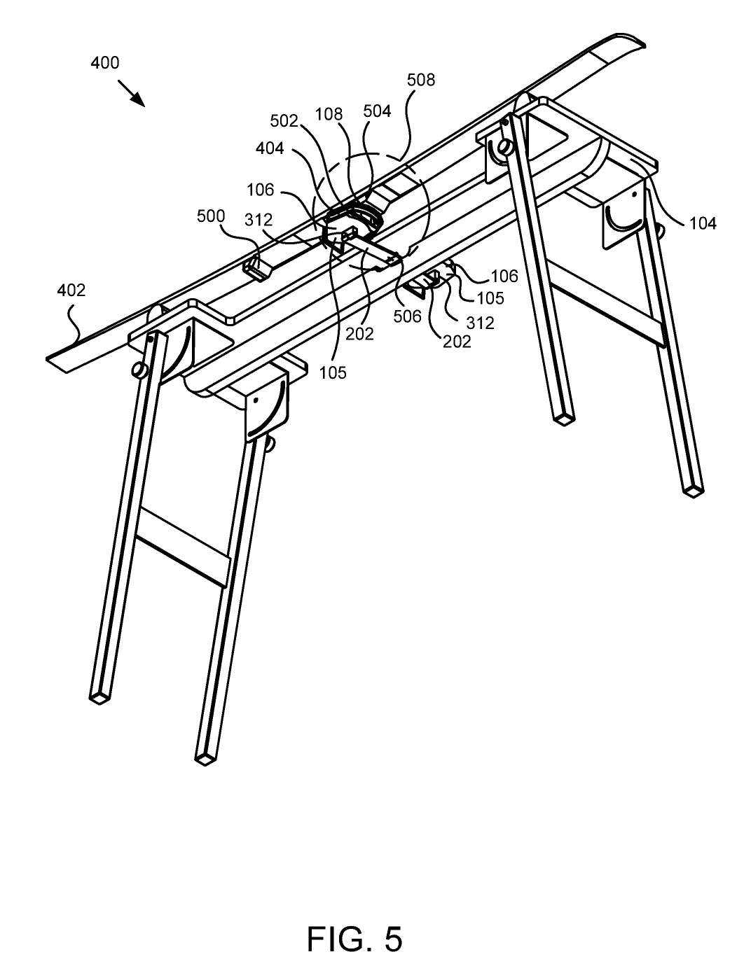

FIG. 5 illustrates a bottom view of one embodiment of the ski tuning apparatus 400 of FIG. 4. One of skill in the art will recognize that the heal piece 500 of a telemark binder typically does not attach to the users boot. Therefore, in certain embodiments, the binder engagement 106 may clamp or otherwise attach to the heal piece 500 of the telemark binder.

In the embodiment illustrated in FIG. 5, the rigid binder engagement element 105 of the binder engagement 106 engages the toe piece 404 of the binder by being received in the gap between the retaining bar 502 and the stomp plate 504 of the telemark binder. The binder retainer 108 encircles the toe piece 404 of the telemark binder to keep the binder engagement element 105 of the binder engagement 106 in the gap between the retaining bar 502 and the stomp plate 504 of the telemark binder. In certain embodiments the connecting structure of the toe piece 404, that is the structure that connects the toe piece 404 to a user's boot, may be used to engage the binder engagement element 105 of the binder engagement 106 with the toe piece 404 of the binder. In such an embodiment the binder retainer 108 may be omitted.

The coupling member 202 may include a hinged support bracket substantially similar to the coupling members 202 discussed above. A hinge 506 that connects the hinged support brackets of the coupling member 202 in the middle. The coupling member 202 is coupled to the support structure 104 in about the center of the support structure 104. As the adjusting members 145 (FIG. 4) are rotated, the hinged support brackets 202 are tilted downward. As discussed above, engagement hinges 312 coupled to the binder engagements element 105 of the binder engagements 106 adjust the plane of the binder engagement elements 105 of the binder engagements 106 to maintain the skis 402 (or skis 114) in parallel alignment with the support structure 104.

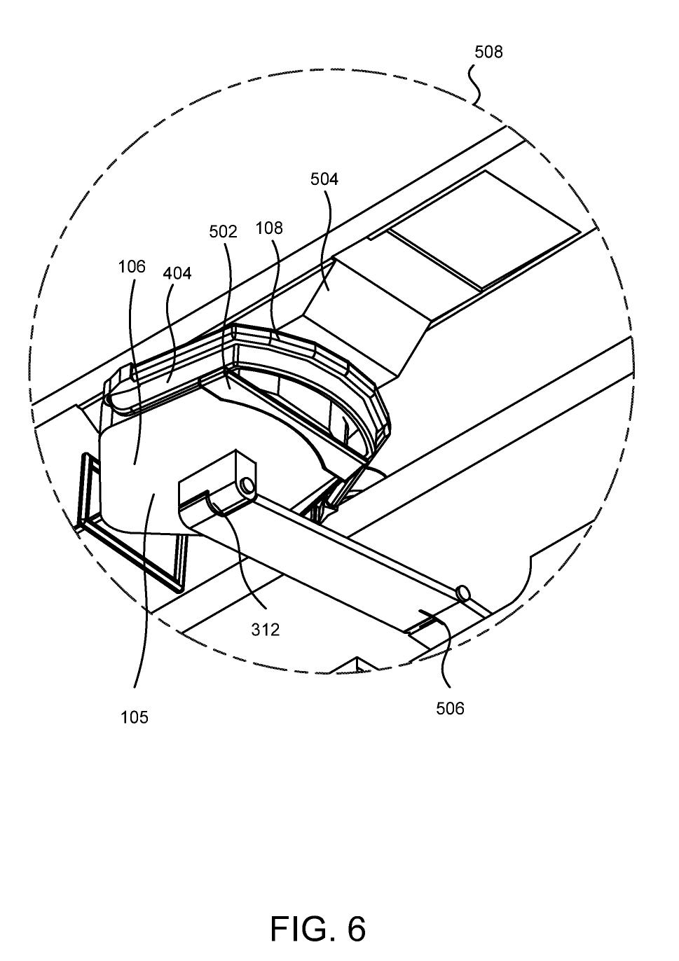

FIG. 6 is a blown up partial view of the of the telemark binder attachment area 508 of FIG. 5 showing one embodiment of the interaction of the binder engagement element 105 of the binder engagement 106 and the binder retainer 108 with the toe piece 404 of a telemark binder. In this embodiment, the binder engagement 106 engages the toe piece 404 by being received in the gap between the retaining bar 502 and the stomp plate 504 of the telemark binder. The binder retainer 108 encircles the toe piece 404 of the telemark binder to keep the binder engagement 106 in the gap between the retaining bar 502 and the stomp plate 504 of the telemark binder.

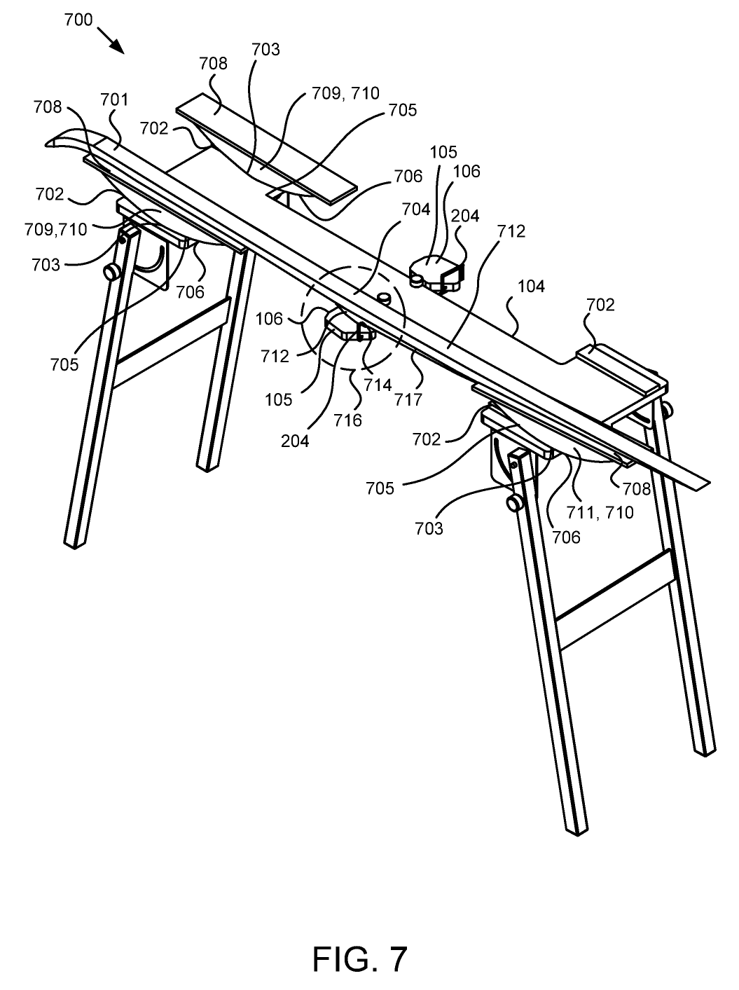

FIG. 7 depicts the ski tuning apparatus 700 according to another embodiment of the present invention. The embodiment illustrated in FIG. 7 shows a cross-country or skate ski 701 mounted on the ski tuning apparatus 100. Cross-country and skate skis 701 are typically more delicate than an alpine 114 or telemark ski 402. Therefore, in certain embodiments the first supports 709 and the second supports 711 (collectively supports 710) may include a ski receiving surface 708 that maintains contact with substantially the same surface area on the deck surface 717 as an angle of the ski 701 changes in response to a pressure applied along the base surface 712 of the ski 701. By maintaining contact with substantially the same surface area on the deck surface 717 as an angle of the ski 701 changes the ski 701 is supported along a larger surface area protecting the ski from damage resulting from the pressure.

While the embodiment discussed with reference to FIG. 7 refers to cross-country and skate skis 701, one of skilled in the art will recognize that in certain embodiments it may be desirable to maintain contact with substantially the same surface area on the deck surface 117 of an alpine or AT skis (such as skis 114) or telemark skis (such as skis 402) to protect an alpine or AT skis (such as skis 114) or telemark skis (such as skis 402) from damage. Accordingly, in certain embodiments the first supports 709 and the second supports 711 may be used with alpine or AT skis (such as skis 114) or telemark skis (such as skis 402). The embodiment discussed with reference to FIG. 7 will be described with reference to a cross-country or skate ski 701. However, one of skill in the art will recognize that the features and advantages of the ski tuning apparatus 700 may be equally applicable to alpine or AT skis (such as skis 114) or telemark skis (such as skis 402).

The supports 710 may be used to transmit the applied loads from the more delicate ends of the skis 701 to the stiffer center portion 704 of the skis 701. The ski receiving surfaces 708 of the first supports 709 and the second supports 711 are positioned opposite semicircular rolling surfaces 706. The semicircular rolling surfaces 706 adjust the angle of the ski receiving surfaces 708 as the semicircular rolling surfaces 706 are rolled in a direction of a pressure applied to the ski 701. In this manner, the ski receiving surfaces 708 maintain contact with substantially the same surface area of the deck surface 717 of the ski as pressure is applied along the base surface 712 of the ski.

In one embodiment the ski receiving surfaces 708 of each support 710 may be recessed to receive the ski 701 to prohibit lateral movement of the ski 701 on the ski receiving surfaces 708. As pressure is applied along the base of a ski 701 the semicircular rolling surface 706 rolls along the support structure 104 to adjust a location of a pivot point 703 on the semicircular rolling surface 706. By adjusting the location of the pivot point 703, the ski receiving surfaces 708 of each support 710 maintains contact with the same area on the deck surface 717 of the ski 701. Thus, as pressure is applied to the center portion 704 of the ski 701, the center portion 704 is depressed causing the support 710 to roll inward in a direction towards the applied pressure. As the support 710 rolls inward the pivot point 703 is adjusted or moved along the semicircular rolling surface 706 and the angle of the ski receiving surface 708 is adjusted. For instance, given enough pressure, the pivot point 703 will be adjusted along the semicircular rolling surface 706 and will reach an adjusted pivot point 705. By moving the pivot point 703 along the semicircular rolling surface 706, the same area of the ski 701 is supported along the entire distance traveled by the semicircular rolling surface 706. One of skill in the art will recognize that the opposite also holds. That is, where pressure is applied to the end of the ski 701 at a point further away from the center portion 704 of the ski 701 than the pivot point 703, the support 710 will roll in the direction of the applied pressure. The pivot point 703, in this case, is adjusted away from the center portion 704 of the ski 701.

An alignment block 702 may be mounted to the support structure 104 under each support 710. The alignment block 702 may be sized to be received within a recess (not shown) located on the semicircular rolling surfaces 706 of the supports 710. As the user applies pressure along the base surface 712 of the ski 701, the supports 710 roll to equally distribute the pressure.

The embodiment illustrated in FIG. 7 shows the binder engagement members 204 engaged in a toe piece 712 of a cross-country or skate ski binder. In such an embodiment, the binder engagement member 204 is pivoted upward to align with a receiving slot 714 or opening in the cross-country or skate ski binder. When the ski tuning apparatus 700 is used with another type of ski such as an alpine or AT ski 114 or a telemark ski 402, the binder engagement member 204 may be pivoted down to avoid interference with the binder engagement 106. In certain embodiments the binder engagement members 204 may be omitted altogether where the binder engagement members 204 are unnecessary or will not be used to attach a cross-country or skate ski 701 binder to the ski tuning apparatus 700.

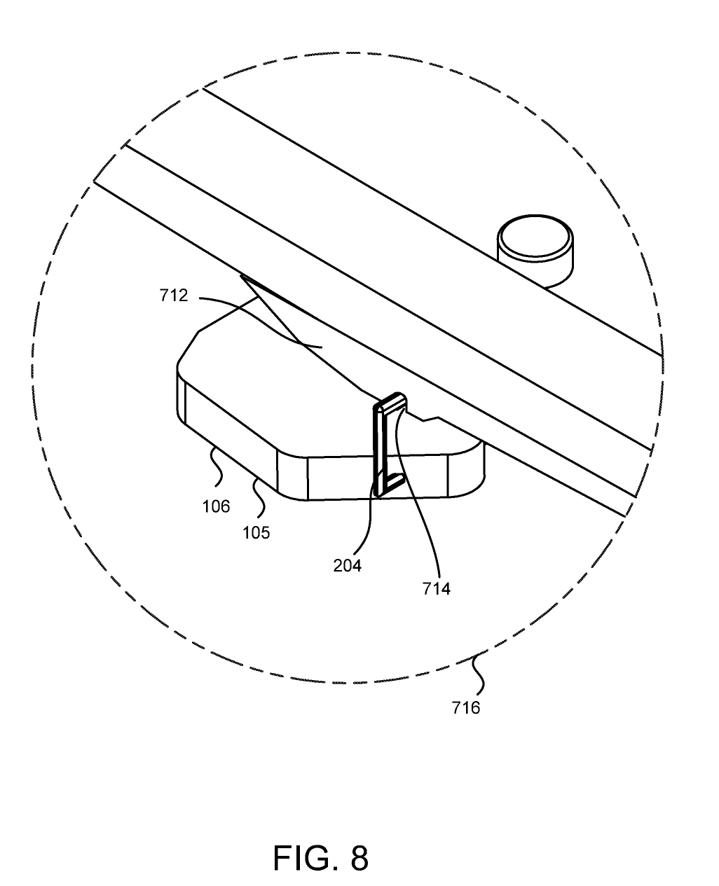

FIG. 8 illustrates a blown up partial view of the cross-country or skate binder attachment area 716 of FIG. 7 showing one embodiment of the interaction of the binder engagement member 204 with the receiving slot 714 or opening of the cross-country or skate ski binder. As discussed above, the binder engagement member 204 is pivoted upward to align with a receiving slot 714 or opening in the cross-country or skate ski binder and the binder engagement member 204 is inserted into the receiving slot 714 or opening in the cross-country or skate ski binder. To release and remove the cross-country or skate ski 701 from the ski tuning apparatus 700, the binder release (not shown) on the binder is depressed and the binder engagement member 204 is removed from the receiving slot 714 or opening in the in the cross-country or skate ski binder in a manner similar to the conventional method for removing a cross-country or skate ski boot from a cross-country or skate ski binder.

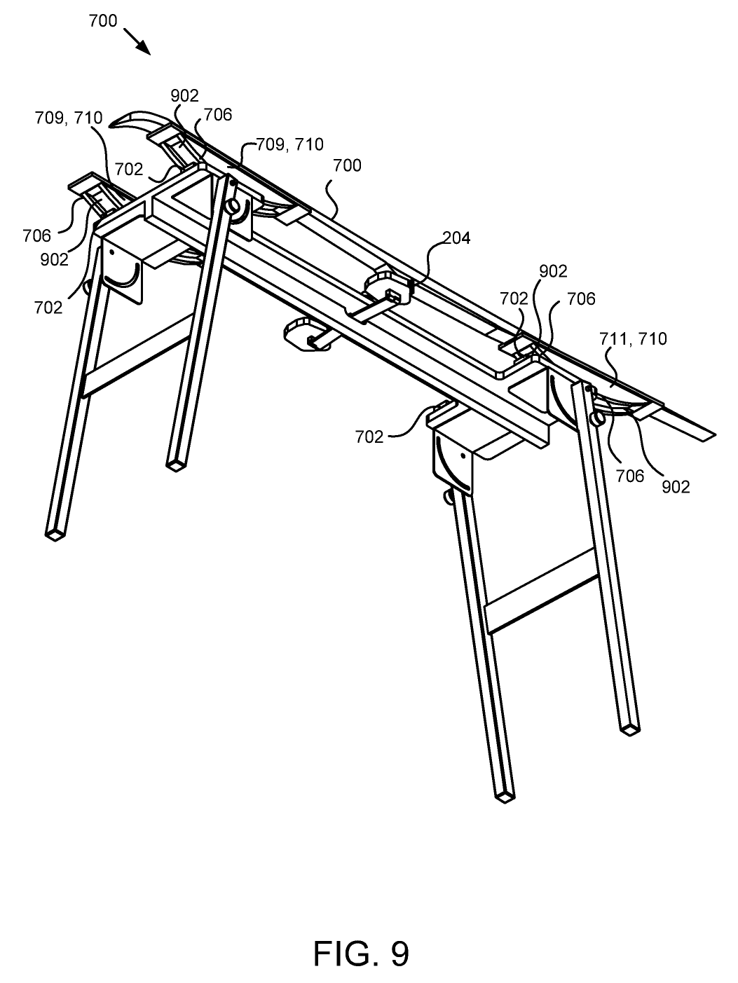

FIG. 9 depicts a view of the bottom of a ski tuning apparatus 700 with a cross-country or skate ski 701 attached to the binder engagement member 204 according to one embodiment. In certain embodiments the supports 710 include recesses 902 located in the semicircular rolling surfaces 706 that are sized to receive alignment blocks 702 to keep the supports in alignment with the ski 701 when supports 710 are rocked in response to force applied by a user.

While the embodiments illustrated in FIG. 7-9 do not show binder engagements 106 having binder retainers 108 attached to them, one of skill in the art will recognize that in certain embodiments the ski tuning apparatus 700 may be universal and may include binder engagement members 204 to attach to cross-country or skate skis 701 as well as binder retainers 108 to attach the binder engagements 106 to alpine skis 114 or telemark skis 402.

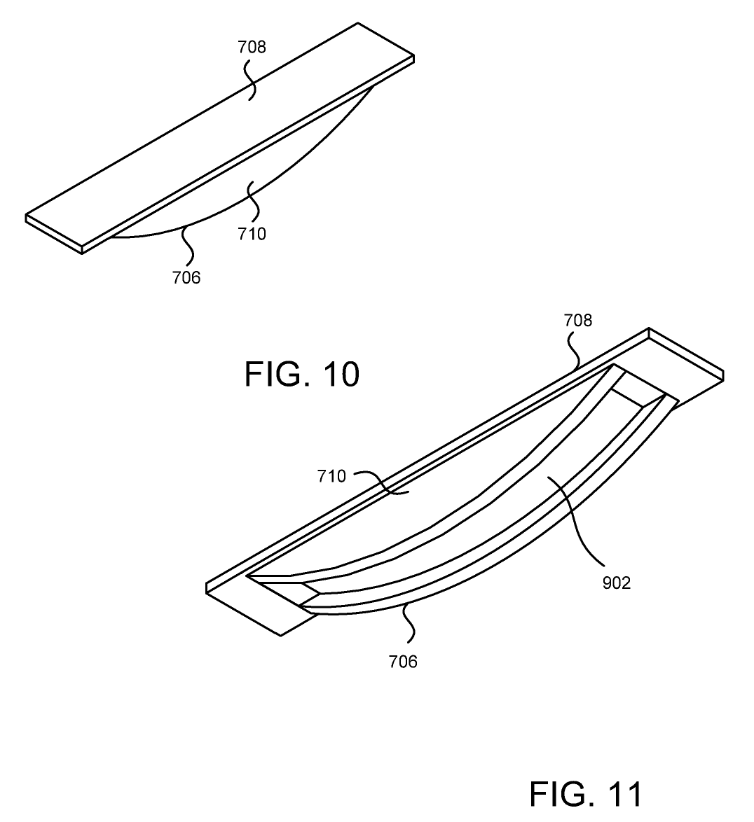

FIGS. 10 and 11 illustrate supports 710 according to one embodiment. In certain embodiments, loads applied to skis such as alpine skis 114, telemark skis 402, or cross-country or skate skis 701 during the tuning process may be great enough to bend or break the ski. Additional support may be required to prevent damage to the skis. This may be particularly true of delicate cross-country or skate skis 701. Therefore, to protect the tip and tail of the skis the supports 710 may support the tips and tails of the skis to transmit the applied loads from the tip or tail of the skis to the center portions of the skis.

In certain embodiments the supports 710 include a substantially planar ski receiving surface 708 and a semicircular rolling surface 706. In one embodiment the semicircular rolling surface 706 includes a recess 902 that is sized to receive an alignment block 702 located on the support structure 104 of a ski tuning apparatus 700. As support 710 is rocked from one end to the other, the alignment block 702 is maintained within the recess 902. By keeping the alignment block 710 in the recess 902 on the support 710, the support 710 is rocked in a straight line along the support structure 104. By rocking the support 710 in a straight line, the ski receiving surface 708 is kept in alignment with the ski.

In certain embodiments the supports 710 are made of a non-skid material, such as rubber or plastic. In other embodiments, only the rolling surface 706 of the support 710 is lined with a non-skid material such as rubber, abrasive sheeting or plastic. In another embodiment the alignment block 702 and/or the recess 902 are lined with a non-skid material such as rubber, abrasive sheeting or plastic to ensure that the supports 710 do not slip under pressure. In yet another embodiment the top surface 142 of the support structure 104 may be lined with a non-skid material such as rubber, abrasive sheeting or plastic. In a further embodiment the ski receiving surface 708 may include a non-skid material that keeps the skis positioned on the ski receiving surface 708.

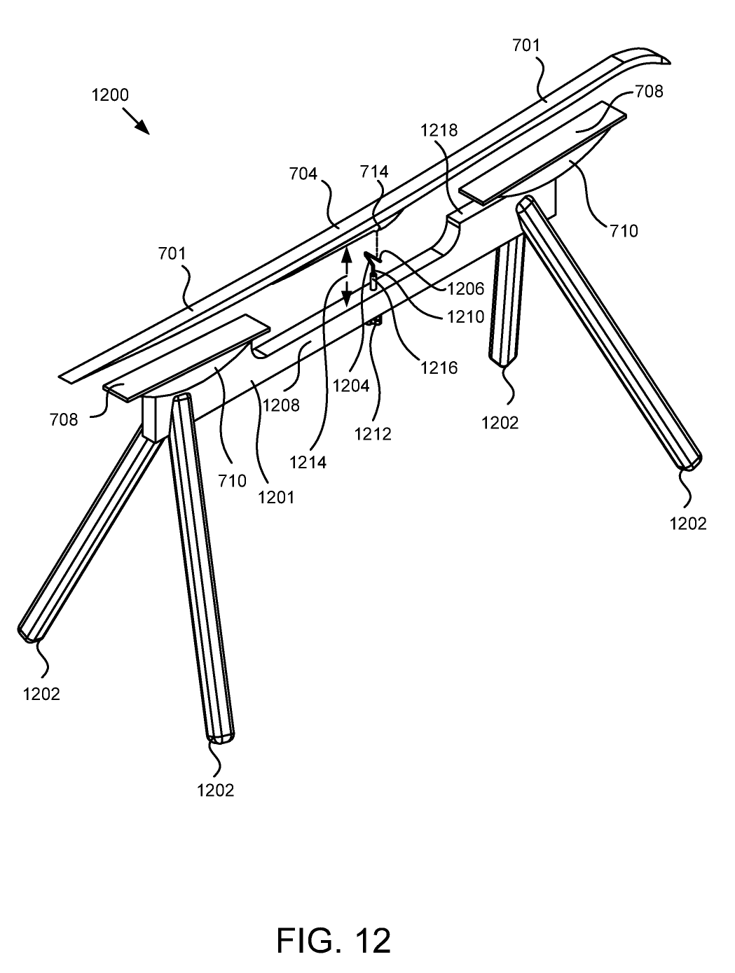

FIG. 12 illustrates another embodiment of a ski tuning apparatus 1200 having a support structure 1201. In certain embodiments the support structure 1201 is shaped similar to a sawhorse and includes a saddle section 1208. The support structure 1201 may also includes leg 1202 which may or may not have extensions (not shown) similar to extensions 130 discussed with reference to FIG. 1 to assist in leveling the ski tuning apparatus 1200 on uneven terrain.

In certain embodiments a binder engagement 1204 attaches a cross-country or skate ski 701 to the ski tuning apparatus 1200. The binder engagement 1204 includes a binder engagement member 1206 that is received within a receiving slot 714 or opening in the cross-country or skate ski binder. In certain embodiments the binder engagement 1204 includes a shank 1210 that is received within a hole in the saddle section 1208 of the support structure 1201 with the shank 1210 spanning the distance between the top of the saddle section 1208 and the bottom of the saddle section 1208. An adjusting member 1212 includes a threaded adjustment nut that is received on a threaded end of the shank 1210. By rotating the adjusting member 1212, the depth of the binder engagement member 1206 can be adjusted in the directions indicated by arrow 1214 to increase or decrease pressure placed on the center portion 704 of the ski 701.

The ski tuning apparatus 1200 may also include supports 710 substantially similar to the supports 710 described above. The supports 710 rock along the top surface 1218 of the support structure 1201. The supports 710 include a ski receiving surface 708 that supports a ski 701. The supports 710 transmit an applied load from the more delicate ends of the ski 701 to a stiffer center portion 704 of the ski 701 in the manner discussed above.

In certain embodiments a pliable spacer 1216 may be included on the shank 1210 of the binder engagement 1204 to allow the binder engagement 1204 to be depressed toward the saddle section 1208 when a load is applied in the center portion 704 of the ski 701. The pliable spacer 1216 may be made of a material that regains its structure once the applied load is removed from the center portion 704 of the ski such that the pliable spacer 1216 returns the binder engagement 1204 to an extended position.

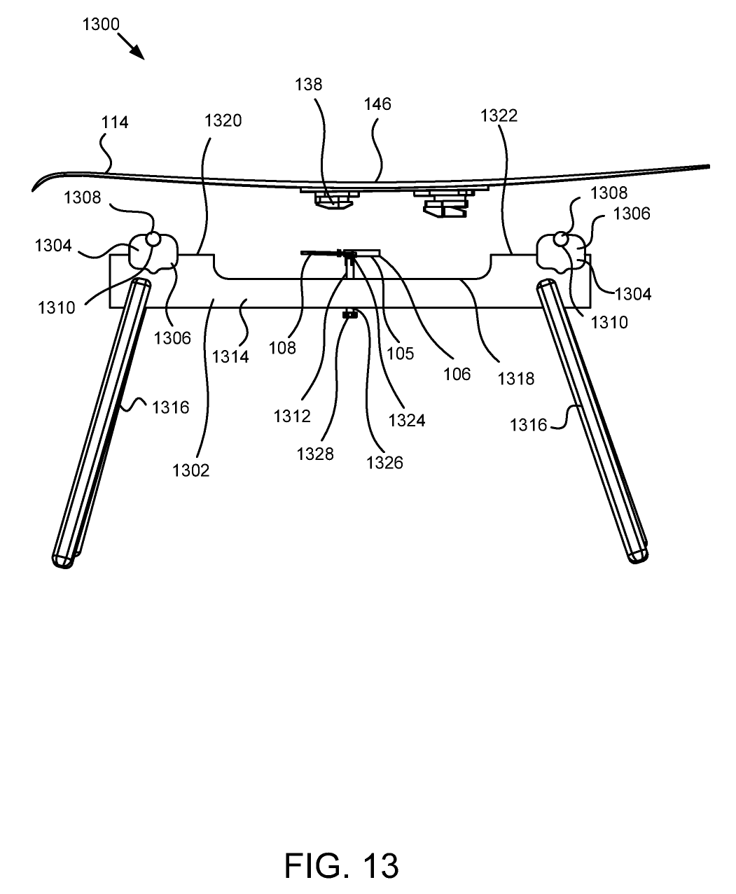

FIG. 13 illustrates another embodiment of a ski tuning apparatus 1300 having a sawhorse like support structure 1302 for supporting the ski tuning apparatus 1300. The support structure 1302 includes legs 1312 with a saddle section 1314 spanning the distance between the legs 1316. The saddle section 1314 may include a depressed area 1318 in the center of the saddle section 1314 with raised areas 1320 and 1322 at each end.

An adjusting member 1328 including a threaded nut, is threaded onto a shank 1312 on the binder engagement 106. The shank 1312 is received within a hole in the depressed area 1318 of the support structure 1302. The shank 1312 spans the depressed area 1318 of the support structure 1302 so that a top end 1324 of the shank 1312 extends from the top of the depressed area 1318 and a bottom end 1326 of the shank 1312 extends below the depressed area 1318. The adjusting member 1328 adjusts the height of the engagement 106 with respect to the support structure 1302 to increase or decrease pressure applied to the center portion 146 of the ski 114 when the engagement 106 is connected to the toe piece 138 of a binder coupled to the ski 114.

In certain embodiments, the rigid binder engagement element 105 of the binder engagement 106 is shaped to engage the toe piece 138 of the binder in a similar fashion to the rigid binder engagement element 105 of the binder engagements 106 described above. A binder retainer 108 encircles the toe piece 138 of the binder to keep the binder engagement 106 engaged with the toe piece 138. One of skill in the art will recognize that in certain embodiments the binder engagement 106 may also in include a binder engagement such as binder engagement member 204 of FIG. 2 such that the ski tuning apparatus 1300 may be used with a alpine or AT ski 114, a telemark ski 40, or a cross-country or skate ski 701.

In one embodiment the ski tuning apparatus 1300 also includes supports 1304. The supports 1304 may include a base 1306 with a support dowel 1308 resting in a cradle 1310 in the support base 1306. To adjust the supports 1304 in a forward or rearward direction a user may slide the support base 1306 along the raised areas 1320 and 1322 at each end of the saddle section 1314 of the support structure 1302. In certain embodiments the support dowel 1308 may be made of a friction resistant non-slip substance such as a rubber or plastic to reduce any lateral movement of the ends of the ski 114 during the ski tuning process. In one embodiment the support dowel 1308 may be made of a soft wood or other semi-pliable substance. In another embodiment the entire support 1304 may be a single unitary item molded using a friction resistant non-slip substance.

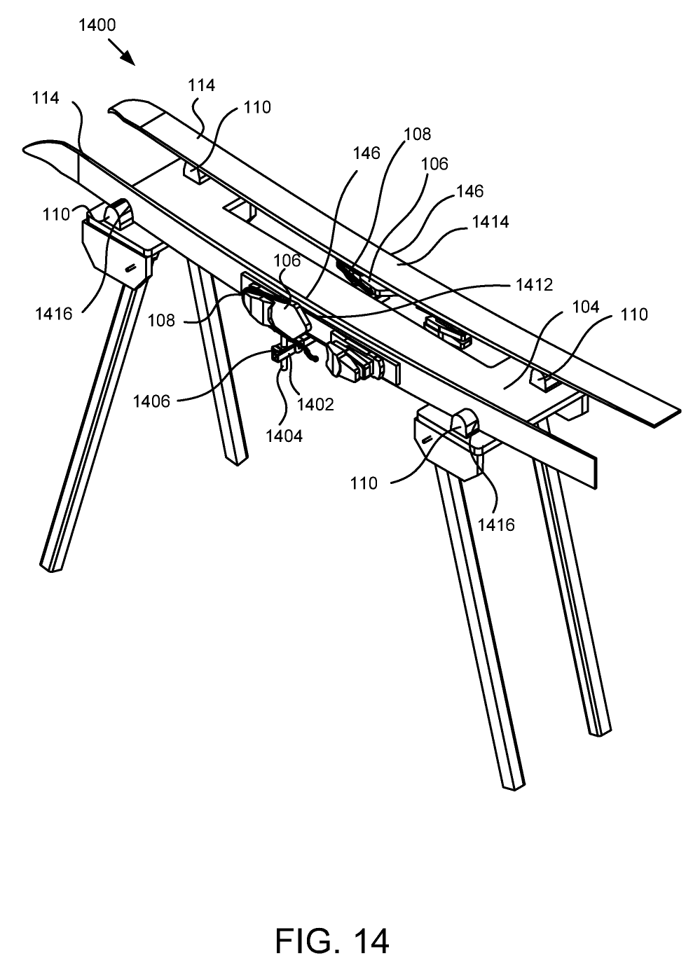

FIG. 14 illustrates another embodiment of a ski tuning apparatus 1400. The ski tuning apparatus 1400 includes a crossbar 1402 for adjustably coupling the binder engagements 106 to the support structure 104. The binder engagements 106 include a dowel 1404 and an adjusting member 1406 that adjusts the height of the binder engagements 106 with respect to the support structure 104.

In certain embodiments the crossbar 1402 receives the dowels 1404 on the binder engagements 106 through holes in the crossbar 1402. The dowels 1404 are slideable within the hole so that the height of the binder engagement 106 may be adjusted relative to the support structure 104. The adjusting members 1406 operate to bind the dowels 1404 in a desired position. To adjust the pressure applied to the center portions 146 of the skis 114, the adjusting members 1406 are depressed allowing the dowels 1404 to slide within the holes in the crossbar 1402. The user then physically increases pressure on the center portions 146 of the ski 114. Once the desired pressure is achieved, the adjusting members 1406 are released and the dowels 1406 are locked in place as a result of a binding action between the dowels 1406 and the adjusting members 1406. In certain embodiments the height of the center portions 146 of the ski 114 may be adjusted for one ski 114 at a time. In other embodiments the height of the center portions 146 of both skis 114 may be adjusted substantially simultaneously. In such an embodiment two user may be required to depress both of the adjusting members 1406 to allow the dowels 1404 to slide within the holes.

In certain embodiments each binder engagement 106 may include a binder engagement hinging member (not shown) coupled to the binder engagement 106. In certain embodiments the binder engagement hinging member may be substantially similar to the binder engagement hinging member 312 described above. The binder engagement hinging member adjusts an angle of the binder engagement 106 from a base servicing position 1414 to an edge servicing position 1412. With the binder engagement 106 positioned in the edge servicing position 1412 by the binder engagement hinging member, the binder engagement 106, and thus the ski 114, is positioned substantially perpendicular to the support structure 104. With the binder engagement 106 positioned in the base servicing position 1414 by the binder engagement hinging member, the binder engagement 106, and thus the ski 114, is positioned substantially parallel to the support structure 104.

In one embodiment the first supports 109 and the second supports 111 may each include a ski profile receiving slot 1416 that receives a profile of a ski 114 with the binder engagement 106 positioned in the edge servicing position 1412 to help maintain the ski 114 vertically in the first position 1414. In one embodiment, the binder engagement 106 may be optionally disengaged from the binder when tuning the edge of the skis 114. For example, with shorter skis, under about 170 cm, the pressures exerted on the edges during an edge sharpening procedure may be such that the engagement 106 may be unnecessary to secure the ski 114. In such an embodiment the engagement 106 may be disengaged from the binder and the profile of the ski 114 may be inserted into the ski profile receiving slot 1416 in the supports 110 to give the user better access to the edge of the ski 114. In another embodiment the supports 110 that include the ski profile receiving slot 1416 may be used on any substantially flat surface to tune the edge of the ski 114 without the binder engagement 106.

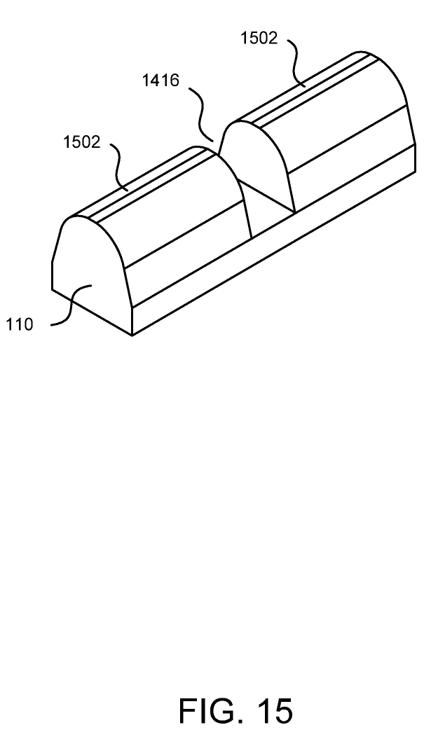

FIG. 15 illustrates an embodiment of a support 110 having a ski profile receiving slot 1416 that receives a profile of a ski 114 (or ski 402, or ski 701) when the ski is positioned in an edge servicing position as described above. In certain embodiments the ends 1502 of the support 110 may be sized to provide support to the ski when the profile of the ski is received within the ski profile receiving slot 1416 to maintain the ski in the edge servicing position. In such an embodiment the support 110 may be made of a material having sufficient structural integrity to support the ski 114 (or ski 402, or ski 701) when the pressure is applied to the ski's edge.

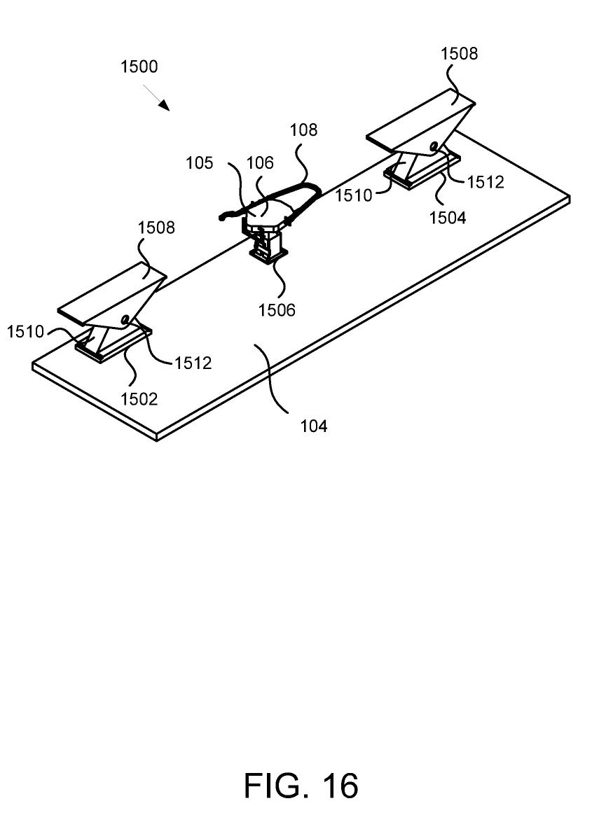

FIG. 16 illustrates an embodiment of a ski tuning apparatus 1500 a ski in a position to maintain the ski. The apparatus includes a first support 1502, a second support 1504, a binder engagement 106, and a coupling member 1506.

The first support 1502 and the second support 1504 each include a ski receiving surface 1508 which is pivotably coupled to a base 1510 by a pivot attachment 1512. The pivot attachments 1512 allow the angles of the ski receiving surfaces 1508 of the first support 1502 and the second support 1504 to adjust as pressure is applied along the base surfaces 112 of the skis 114 (or base surfaces 712 of skis 701). In this manner, the ski receiving surfaces 1508 maintain contact with substantially a same surface area of the deck surfaces 112 of the skis 114 (or deck surfaces 717 of skis 701) as an angle of the ski changes in response to a pressure applied along the base surfaces 112 of the skis 114 (or base surfaces 712 of skis 701). By adjusting the angle of the ski receiving surfaces 1508 a greater area of the skis 114 or skis 701 is supported thereby reducing the risk of damaging the skis 114 or skis 701.

The binder engagement 106 includes a rigid binder engagement member 105 that is engageable with a binder toe piece 138 or a binder heal piece 140 in a manner substantially similar to the manner discussed above. A binder retainer 108 may also function substantially similar to the binder retainers 108 discussed above to keep the binder engagement member engaged with the binder toe piece 138 or the binder heal piece 140.

The coupling member 1506 couples the binder engagement 106 to the support structure 104 to prevent movement of the ski 114 (or ski 701) relative to the support structure 104 in a forward or rearward direction. In the embodiment illustrated in FIG. 15, the support structure 104 includes a substantially planar surface such as a top to a work bench or other tabletop. One of skill in the art will recognize that in certain embodiments the apparatus 1500 may include a support structure 104 specifically designed to support the tuning apparatus 1500 such the support structures 104 described above.

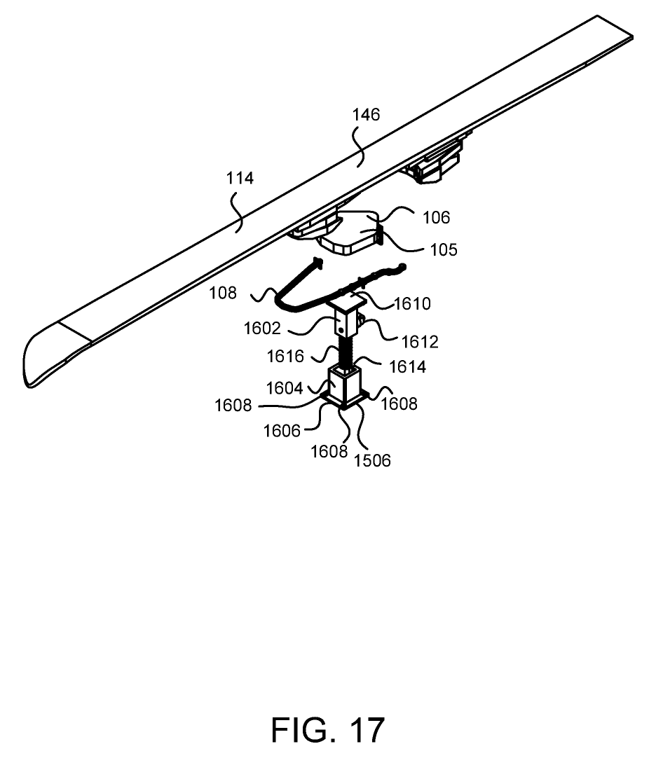

FIG. 17 depicts an exploded view of one embodiment of the coupling member 1506, the binder engagement 106, and the binder retainer 108 of FIG. 16.

In certain embodiments the coupling member 1506 includes an slideable shaft 1602 received within a coupling base 1604. The slideable shaft 1602 may be sized to be received within the coupling base 1604 and slide up and down within the coupling base 1604.

The coupling base 1604 may include an attachment flange 1606 that couples the base member 1604 to the support structure 104. In certain embodiments the attachment flange 1606 is coupled to the support structure 104 by screws 1608 or other fasteners. In one embodiment the coupling base 1604 may include a clamping structure (not shown) that removably clamps the coupling base 1604 to the support structure 104. One of skill in the art will recognize that the coupling base 1604 may be coupled to the support structure by a variety of different mechanisms.

The slideable shaft 1602 may include an attachment plate 1610 that couples the binder engagement 106 to the slideable shaft 1602. Thus, as the slideable shaft 1602 is slid within the coupling base 1604, the height of the binder engagement 106 is adjusted with respect to the support structure 104.

An adjusting member 1612 alternatively allows and disallows the height of the slideable shaft 1602 to be changed with respect to the coupling base 1604. The adjusting member 1612 slides within an adjustment slot 1614 when the slideable shaft 1602 is raised or lowered with respect to the coupling base 1604. In certain embodiments the adjusting member 1612 pivots from between a locking position and an unlocking position to lock the height of the slideable shaft 1602 with respect to the coupling base 1604. Because the binder engagement 106 is coupled to the slideable shaft 1602, and the coupling base 1604 is coupled to the support structure 104, the adjusting member also operates to adjust the height of the binder engagement 106. The by locking the binder engagement 106 at a certain height, the coupling member both applies the restricting force and provides support to the center portion 146 of the ski 114.

In certain embodiments a spring 1616 may be positioned within the coupling base 1604 between the slideable shaft 1602 and the coupling base 1604. The spring 1616 may be biased to aid in raising the slideable shaft 1602 from within the coupling base 1604.

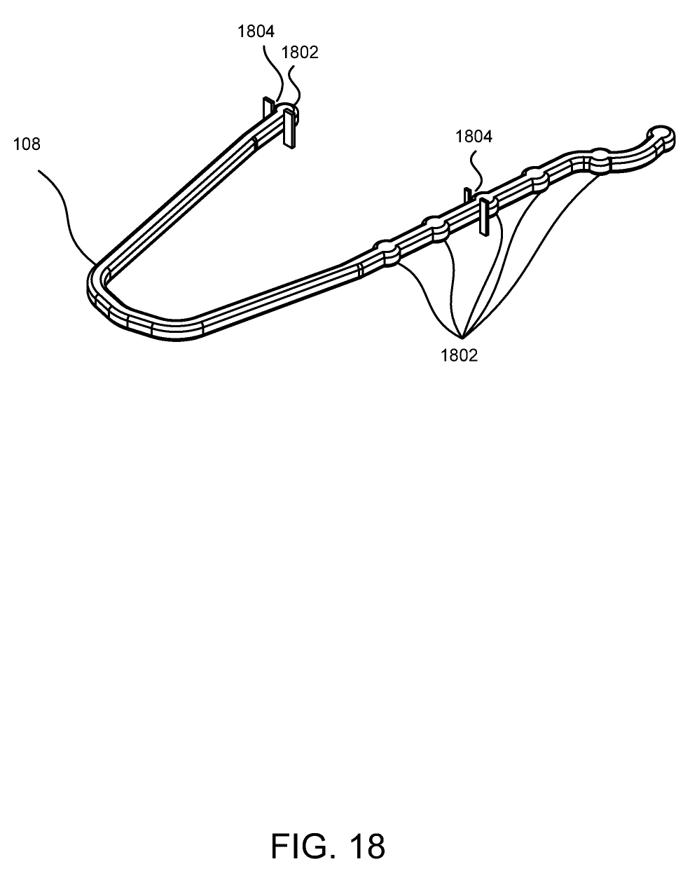

FIG. 18 illustrates one embodiment of a binder retainer 108. In certain embodiments the binder retainer 108 includes nodes 1802 that are received in rigid slots 1804 mounted to the binder engagements 106. The binder retainers 108 may be made of a pliant, stretchable material such as rubber and may be stretched around the toe pieces 138 or heal pieces 140 of the binders. Once the desired tension is achieved the node 1802 may be inserted into the rigid slot 1804 to maintain the tension around the toe pieces 138 or heal pieces 140 of the binder to keep the binder engagements 106 engaged with the binders.

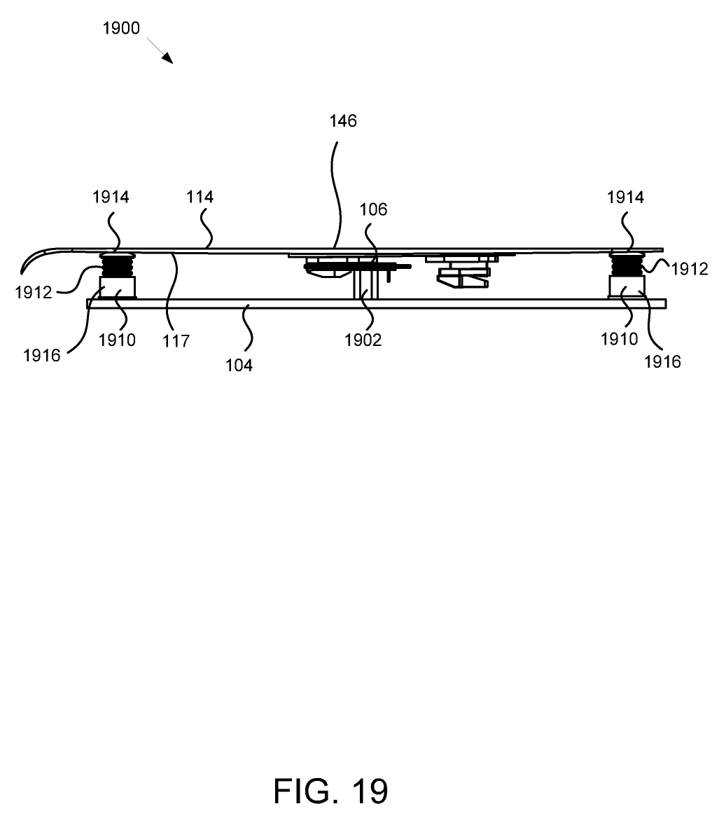

FIG. 19 depicts an embodiment of a ski tuning apparatus 1900 wherein the binder engagement 106 is positioned a predefined distance from the support structure 104 in a fixed plane parallel to the support structure 104. The ski tuning apparatus 1900 includes a binder engagement 106 and supports 1910.

The binder engagement 106 is coupled to the support structure 104 by a coupling member 1902 which positions the binder engagement in a fixed plane a predefined distance away from the support structure 104. In certain embodiments the coupling member 1902 does not include an adjusting member such that the center portion 146 of the ski 114 is maintained at the height of the binder engagement 106. The coupling member 1902 both supports the center portion 146 of the ski 114 and applies a restricting force to the center portion 146 of the ski 114 when the binder engagement 106 is engaged with the binder.

To increase the pressure between the supports 1910 and the deck surface of the ski 114, each support 1910 may include an adjusting member 1912 to adjust the distance between the support structure and the front portion 113 and the rear portion 115 of the ski 114. In the embodiment illustrated in FIG. 19, the adjusting member 1912 includes threads located on each support 1910. By rotating the ski receiving surface 1914 in a first direction with respect to the base 1916 of the support 1910, the ski receiving surface is raised with respect to the base 1916. Rotation of the ski receiving surface 1914 in the opposite direction operates to lower the ski receiving surface 1914.

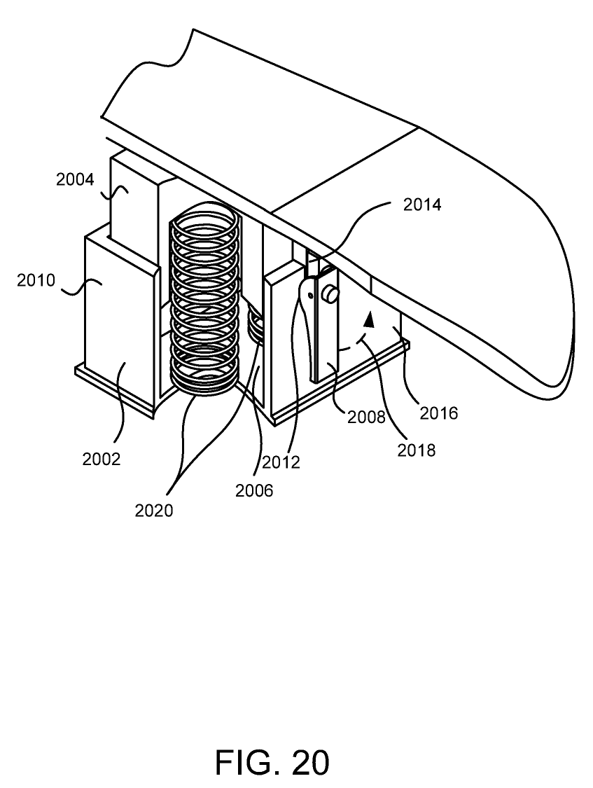

FIG. 20 depicts a partial cutaway view of a support 2010 according to another embodiment. The support 2010 includes a base support 2002 that receives an upper portion 2004 within a recess 2006 in the base support 2002. The upper portion 2004 is slidably received within the base support 2002 such that the upper portion 2004 can slide up and down within the base support 2002.

An adjustment member 2008 operates to alternately lock and unlock the height of the upper portion 2004 with respect to the base support 2002. The adjustment member 2008 slides within a slot 2014 in the base support 2002 when the upper portion in slid within the base support 2002.

A camming lobe 2012 on the adjustment member 2008 draws the upper portion 2004 towards the wall 2016 of the base support 2002 when the adjustment member 2008 is positioned in the position illustrated in FIG. 20. With the adjustment member positioned in this position, the adjustment member 2008 effectively locks the height of the upper portion 2004 relative to the base support 2002. When the adjustment member 2008 is pivoted in the direction indicated by arrow 2018, the upper portion 2004 is no longer drawn towards the wall 2016 of the base support 2002 and the upper portion 2004 can freely slide within the recess 2006 of the base support 2002. In this manner the height of the support 2010 can be adjusted.

In certain embodiments one or more springs 2020 may be positioned within the recess 2006 of the base support 2002 between the base support 2002 and the upper portion 2004. The springs 2020 may be biased to cause the upper portion 2004 to be slid up when the adjustment member 2008 is unlocked. To lower the height of the upper portion 2004, a user may apply pressure to the upper portion 2004 greater than the biasing pressure of the springs 2020 to cause the upper portion 2004 to be received at a lower position within the recess 2006 of the base support 2002.

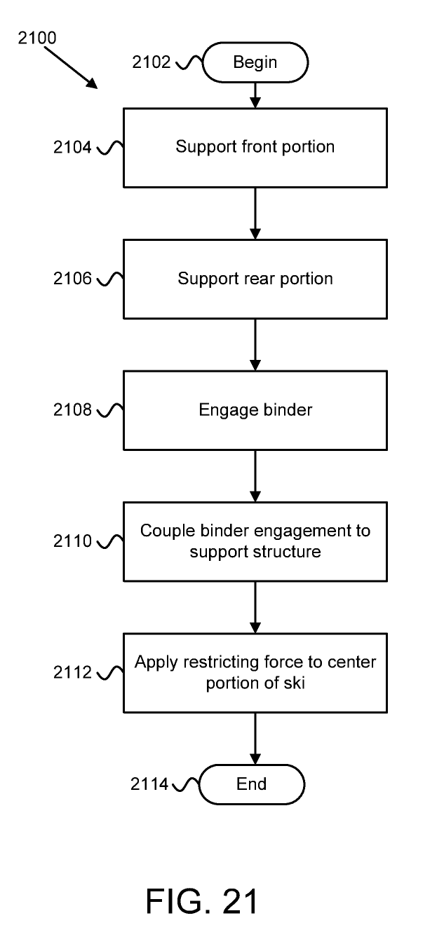

FIG. 21 depicts a method 2100 for retaining a ski in a position to maintain the ski. The method is described with reference to an alpine or AT ski 114. One of skill in the art will recognize that the method 2100 may be practiced with a telemark ski 402 or a skate or cross country ski 701.

The method includes supporting 2104 the front portion 113 of the skis 114 with a first support 109 and supporting 2106 a rear portion 115 of the skis 114 with a second support 111. In certain embodiments the ski includes a tunable base surface 112 opposite a deck surface 117. The first support 109 is positioned between the deck surface 117 on the front portion 113 of the ski 114 and a support structure 104. The second support 111 is positioned between the rear portion 115 of the ski 114 and the support structure 104.

The method 2100 also includes engaging 2108 a binder with a binder engagement 106 coupleable to the support structure 104. The binder engagement 106 includes a rigid engagement element 105 that is engageable with the binder coupled to the deck surface 117 of a center portion 146 of the ski 114. The binder includes at least one of a binder toe piece 138 and a binder heal piece 140. The binder engagement 106 engages only one of the binder toe piece 138 and the binder heal piece 140.

The binder engagement 106 is coupled 2110 to the support structure 104 with a coupling member 202. The coupling member 202 prevents movement of the ski 114 relative to the support structure 104 in a forward and a rearward direction.

A restricting force is applied 2112 to the center portion 146 of the ski 114 when the binder engagement 106 is engaged with the binder. The restricting force limits the distance between the center portion 146 of the ski 114 and the support structure 104. The first support 109 and the second support 111 apply an opposing force to the front portion 113 and the rear portion 115 of the ski 114. The opposing force is applied in a direction opposite the restricting force to secure the ski 114.

In certain embodiments the method 2100 also includes adjusting a distance between the support structure 104 and at least one of the front portion 113 of the ski 114, the center portion 146 of the ski 114, and the rear portion 115 of the ski 113 with at least one adjusting member 145. The at least one adjusting member 145 may be positioned on at least one of the first support 109, the second support 111, and the coupling member 202. Adjustment of the at least one adjusting member 145 adjusts a pressure between at least one of the front portion 113 of the ski 114 and the first support 109 and the rear portion 115 of the ski 114 and the second support 111.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A ski tuning apparatus for retaining a ski in a position to maintain the ski, the apparatus comprising:
a first support supporting a front portion of a ski, the ski comprising a tunable base surface opposite a deck surface, the first support positioned between the front portion of the ski and a support structure;
a second support supporting a rear portion of the ski, the second support positioned between the rear portion of the ski and the support structure;
a binder engagement coupleable to the support structure and positioned between the first and second supports, the binder engagement comprising a rigid engagement element engageable with a binder coupled to the deck surface of a center portion of the ski, the binder comprising at least one of a binder toe piece and a binder heal piece, wherein the binder engagement is engageable with only one of the binder toe piece and the binder heal piece;
a coupling member that couples the binder engagement to the support structure, the coupling member preventing movement of the ski relative to the support structure in a forward and rearward direction; and
wherein, when the binder engagement engages the binder, the binder engagement applies a restricting force to the center portion of the ski, the restricting force limiting the distance between the center portion of the ski and the support structure, wherein the first support and the second support apply an opposing force to the front portion and the rear portion of the ski respectively, the opposing forces applied in a direction substantially opposite the restricting force to retain the ski.

2. The ski tuning apparatus of claim 1, wherein the first support comprises a slip resistant material that prevents movement of the front portion of the ski in a plane parallel with the ski, wherein the second support comprises a slip resistant material that prevents movement of the rear portion of the ski in a plane parallel with the ski.

3. The ski tuning apparatus of claim 1, wherein the coupling member applies a support force in a same direction as the opposing forces applied by the first and second supports such that the center portion of the ski is supported when pressure is applied to the center portion of the ski.

4. The ski tuning apparatus of claim 1, wherein at least one of the first support, the second support, and the coupling member comprises at least one adjusting member, the at least one adjusting member adjusting a distance between the support structure and at least one of the front portion of the ski, the center portion of the ski, and the rear portion of the ski, wherein adjustment of the at least one adjusting member adjusts a pressure between at least one of the front portion of the ski and the first support and the rear portion of the ski and the second support.

5. The ski tuning apparatus of claim 4, wherein the coupling member comprises the at least one adjusting member and wherein adjusting the at least one adjusting member decreases a distance between the center portion of the ski and the support structure to increase the pressure between the front portion of the ski and the first support member and increase the pressure between the rear portion of the ski and the second support, the increased pressure increasing a frictional resistance between the front portion of the ski and the first support and the rear portion of the ski and the second support, the increased frictional resistance decreasing lateral movement of the ski with respect to the first support and the second support.

6. The ski tuning apparatus of claim 4, wherein at least one of the first support and the second support comprises at least one adjusting member, wherein adjusting the at least one adjusting member increases a distance between the support structure and at least one of the front portion of the ski and the rear portion of the ski to increase the pressure between at least one of the front portion of the ski and the first support and the rear portion of the ski and the second support, the increased pressure increasing a frictional resistance between at least one of the front portion of the ski and the first support and the rear portion of the ski and the second support, the increased frictional resistance decreasing lateral movement of the ski with respect to the first support and the second support.

7. The ski tuning apparatus of claim 1, further comprising a binder retainer, wherein the binder toe piece comprises a recess positioned on one side of the binder toe piece, the binder engagement being receivable within the recess of the binder toe piece, the binder retainer encircling the binder toe piece and adjustably coupling to the binder engagement to retain the binder engagement within the recess on the binder toe piece.

8. The ski tuning apparatus of claim 1, further comprising a binder retainer, wherein the binder heal piece comprises a recess positioned on one side of the binder heal piece, the binder engagement being receivable within the recess of the binder heal piece, the binder retainer encircling the binder heal piece and adjustably coupling to the binder engagement to retain the binder engagement within the recess on the binder heal piece.

9. The ski tuning apparatus of claim 1, further comprising a binder engagement member coupled to the binder engagement, the binder engagement member extending through an opening in the binder to couple the binder to the binder engagement.

10. The ski tuning apparatus of claim 1, wherein the first support and the second support each comprise a ski receiving surface, the ski receiving surface maintaining contact with substantially a same surface area of the deck surface of the ski as an angle of the ski changes in response to a pressure applied along the base surface of the ski.

11. The ski tuning apparatus of claim 10, wherein the ski receiving surfaces of the first support and the second support are positioned opposite a semicircular rolling surface of the first support and the second support, the semicircular rolling surface adjusting an angle of the ski receiving surface as the semicircular rolling surface is rolled in a direction of a pressure applied to base surface of the ski such that the ski receiving surface maintains contact with substantially the same surface area of the deck surface of the ski as pressure is applied along the base surface of the ski.

12. The ski tuning apparatus of claim 10, wherein the ski receiving surfaces of the first support and the second support are each pivotably coupled to a base by a pivot attachment, such that an angle of the ski receiving surface is adjusted as pressure is applied along the base surface of the ski.

13. The ski tuning apparatus of claim 1, further comprising a binder engagement hinging member coupled to the binder engagement, the binder engagement hinging member adjusting a position of the binder engagement between a base servicing position and an edge servicing position, wherein in the base servicing position the binder engagement is substantially parallel to the support structure and wherein in the edge servicing position the binder engagement is substantially perpendicular to the support structure.

14. The ski tuning apparatus of claim 13, wherein the first support and the second support each comprise a ski profile receiving slot that receives a profile of the ski with the binder engagement engaging the binder in the edge servicing position.

15. A ski tuning apparatus for retaining a ski in a position to maintain the ski, the apparatus comprising:
a first support supporting a front portion of a ski, the ski comprising a tunable base surface opposite a deck surface, the first support positioned between the front portion of the ski and a support structure;
a second support supporting a rear portion of the ski, the second support positioned between the rear portion of the ski and the support structure;
a binder engagement coupleable to the support structure and positioned between the first and second supports, the binder engagement comprising a rigid engagement element engageable with a binder coupled to the deck surface of a center portion of the ski, the binder comprising at least one of a binder toe piece and a binder heal piece, wherein the binder engagement engages only one of the binder toe piece and the binder heal piece;
a coupling member that couples the binder engagement to the support structure, the coupling member preventing movement of the ski relative to the support structure in a forward and rearward direction; and
wherein at least one of the first support, the second support, and the coupling member comprises at least one adjusting member, the at least one adjusting member adjusting a distance between the support structure and at least one of the front portion of the ski, the center portion of the ski, and the rear portion of the ski, wherein adjustment of the at least one adjusting member adjusts a pressure between at least one of the front portion of the ski and the first support and the rear portion of the ski and the second support.

16. The ski tuning apparatus of claim 15, wherein the first support comprises a slip resistant material that prevents movement of the front portion of the ski in a plane parallel with the ski, wherein the second support comprises a slip resistant material that prevents movement of the rear portion of the ski in a plane parallel with the ski.

17. The ski tuning apparatus of claim 15, further comprising a binder retainer adjustably coupled to the binder engagement, the binder engagement received within a recess on one of the binder toe piece and the binder heal piece, wherein the binder retainer encircles one of the binder toe piece and the binder heal piece to releasably couple the binder engagement to the binder.

18. The ski tuning apparatus of claim 15, further comprising a binder engagement hinging member coupled to the binder engagement, the binder engagement hinging member adjusting a position of the binder engagement between a base servicing position and an edge servicing position, wherein in the base servicing position the binder engagement is substantially parallel to the support structure and wherein in the edge servicing position the binder engagement is substantially perpendicular to the support structure, wherein the first support and the second support each comprise a ski profile receiving slot that receives a profile of the ski with the binder engagement in the edge servicing position.

19. A method for retaining a ski in a position to maintain the ski, the method comprising:
supporting a front portion of a ski with a first support, the ski comprising a tunable base surface opposite a deck surface, the first support positioned between the front portion of the ski and a support structure;
supporting a rear portion of a ski with a second support, the second support positioned between the rear portion of the ski and the support structure;
engaging a binder with a binder engagement coupleable to the support structure, the binder engagement comprising a rigid engagement element that is engageable with the binder coupled to the deck surface of a center portion of the ski, the binder comprising at least one of a binder toe piece and a binder heal piece, wherein the binder engagement engages only one of the binder toe piece and the binder heal piece;
coupling the binder engagement to the support structure with a coupling member, the coupling member preventing movement of the ski relative to the support structure in a forward and rearward direction; and
applying a restricting force to the center portion of the ski with the binder engagement when the binder engagement engages the binder, the restricting force limiting the distance between the center portion of the ski and the support structure, wherein the first support and the second support apply an opposing force to the front portion and the rear portion of the ski, the opposing force applied in a direction opposite the restricting force to secure the ski.

20. The method of claim 19, further comprising adjusting a distance between the support structure and at least one of the front portion of the ski, the center portion of the ski, and the rear portion of the ski with at least one adjusting member on at least one of the first support, the second support, and the coupling member, wherein adjustment of the at least one adjusting member adjusts a pressure between at least one of the front portion of the ski and the first support and the rear portion of the ski and the second support.
